(19) United States
(12) Patent Application Publication
(10) Pub. No.: US 2025/0348537 A1
(43) Pub. Date: Nov. 13, 2025

(54) INFORMATION PROCESSING DEVICE, USER TERMINAL AND INFORMSTION PROCESSING METHOD

(71) Applicant: MICWARE CO., LTD., Kobe-shi (JP)

(72) Inventors: Kenji NARUSHIMA, Kobe-shi (JP); Riko SHIBATA, Sanda-shi (JP)

(21) Appl. No.: 19/278,779

(22) Filed: Jul. 24, 2025

Related U.S. Application Data
(63) Continuation of application No. PCT/JP2023/003446, filed on Feb. 2, 2023.

(51) Int. Cl. G06F 16/732; G06F 16/78; G06F 16/787

(52) U.S. Cl. CPC G06F 16/732; G06F 16/7867; G06F 16/787

(57) ABSTRACT

In the conventional technology, it is impossible to obtain the video and the situation of a predetermined location at a plurality of points in time. An information processing device 1 including: an inquiry receiver 122 configured to receive an inquiry including a location information; a video obtainer 131 configured to obtain a video at a location identified by the location information at a plurality of points in time; a situation obtainer 132 configured to obtain a situation information for identifying a situation of a place identified by the location information; a screen generator 133 configured to generate a screen based on the video at the plurality of points in time; and a screen transmitter 141 configured to transmit the screen to a user terminal 3. Thus, the video and the situation information at a predetermined location at a plurality of points in time can be obtained.

### CROSS-REFERENCE TO RELATED APPLICATIONS

This application claims the benefit of priority and is a Continuation application of the prior International Patent Application No. PCT/JP2023/003446, with an international filing date of Feb. 2, 2023, which designated the United States, the entire disclosures of all applications are expressly incorporated by reference in their entirety herein.

### TECHNICAL FIELD

The present invention relates to an information processing device and the like for providing videos corresponding to an inquiry from a user.

### BACKGROUND OF THE INVENTION

In the conventional technology, there is the technology for displaying a location of interest including: a step of obtaining a street view image; a step of performing a recognition processing on the street view image to obtain a recognition result including a text information about the street view image; and selecting a candidate location of interest matching the text information as a visible location of interest (shown in Patent Document 1).

### PRIOR ART

### Patent Documents

[Patent Document 1] Japanese Patent Publication No. 2016-24806

### SUMMARY OF THE INVENTION

### Problem to be Solved by the Invention

However, it is impossible to obtain the video of a predetermined location at a plurality of points in time in the conventional technology.

### Means for Solving the Problems

An information processing device of the first aspect of the present invention is the information processing device including: an inquiry receiver configured to receive an inquiry including a location information; a video obtainer configured to obtain a video of a location identified by the location information at a plurality of points in time; a situation obtainer configured to obtain a situation information for identifying a situation of the location identified by the location information in a future; a screen generator configured to generate a screen including the situation information based on the video at the plurality of points in time; and a screen transmitter configured to transmit the screen to a user terminal.

The above described configuration allows to provide the video of a predetermined location at a plurality of points in time and the information of the predetermined location in the future.

An information processing device of the second aspect of the present invention is the information processing device according to the first aspect, wherein the situation information includes a weather information for identifying a weather.

The above described configuration allows to also provide the predicted weather information of the predetermined location in the future.

An information processing device of the third aspect of the present invention is the information processing device according to the second aspect, wherein the video obtainer is configured to obtain the video corresponding to the weather information at the plurality of points in time.

The above described configuration allows to also provide the video corresponding to the predicted weather in the future.

An information processing device of the fourth aspect of the present invention is the information processing device according to any one of the first to third aspects, wherein the inquiry includes the location information, a time information and the weather information, and the video obtainer is configured to obtain the video corresponding to the location information, the time information and the weather information included in the inquiry from a mobile storage storing the video associated with three or more attribute values including the location information, the time information and the weather information.

The above described configuration allows to search the video using the location, the time and the weather.

An information processing device of the fifth aspect of the present invention is the information processing device according to any one of the first to fourth aspects, wherein the video obtainer refers to a group manager storing a group information including a plurality of location information and obtain a plurality of videos including the video of the location identified by another location information paired with the location information included in the inquiry.

The above described configuration allows to provide the video of another location related to the predetermined location.

An information processing device of the sixth aspect of the present invention is the information processing device according to the fifth aspect, wherein the video obtainer is configured to obtain the video of the location identified by another location information when the video of the location identified by the location information included in the inquiry cannot be obtained.

The above described configuration allows to provide the video of another location related to the predetermined location when the video of the location identified by the location information included in the inquiry cannot be obtained.

An information processing device of the seventh aspect of the present invention is the information processing device according to any one of the first to sixth aspects, wherein the video at a plurality of points in time includes a current video and a past video of the location identified by the location information, and the screen generator is configured to generate a screen including a plurality of videos in time order.

The above described configuration allows to provide the screen including the videos of the predetermined location at the time of current and past.

An information processing device of the eighth aspect of the present invention is the information processing device according to any one of the first to seventh aspects, further including a third preserver configured to accumulate the video at the plurality of points in time or the screen at the plurality of points in time while being associated with a right holder identifier for identifying a user of the user terminal.

The above described configuration allows to set the user requiring the video as the right holder of the video.

A user terminal of the ninth aspect of the present invention is the user terminal including: a user acceptor configured to accept an inquiry including a location information; a user transmitter configured to transmit the inquiry to the information processing device; a user receiver configured to receive a screen which is based on the video of the location identified by the location information at the plurality of points in time; and a user output unit configured to output the screen.

The above described configuration allows to obtain the video of the predetermined location at a plurality of points in time.

### Effects of the Invention

The information processing device of the present invention allows to provide the video of the predetermined location at a plurality of points in time.

### BRIEF DESCRIPTION OF DRAWINGS

FIG. 1 is a schematic diagram of an information system A in the first embodiment.

FIG. 2 is a block diagram of the information system A in the first embodiment.

FIG. 3 is a block diagram of an information processing device 1 in the first embodiment.

FIG. 4 is a flowchart for explaining an operation example of the information processing device 1 in the first embodiment.

FIG. 5 is a flowchart for explaining an example of a timing determination process in the first embodiment.

FIG. 6 is a flowchart for explaining an example of a terminal determination process in the first embodiment.

FIG. 7 is a flowchart for explaining an example of a current video obtaining process.

FIG. 8 is a flowchart for explaining an example of a screen generating process.

FIG. 9 is a flowchart for explaining an example of a fourth preservation process in the first embodiment.

FIG. 10 is a flowchart for explaining an example of a rewarding process in the first embodiment.

FIG. 11 is a flowchart for explaining a first operation example of a providing terminal 2 in the first embodiment.

FIG. 12 is a flowchart for explaining an operation example of a user terminal 3 in the first embodiment.

FIG. 13 is a drawing showing a group management table in the first embodiment.

FIG. 14 is a drawing showing a terminal management table in the first embodiment.

FIG. 15 is a drawing showing a video management table in the first embodiment.

FIG. 16 is a diagram showing an example of a screen in the first embodiment.

FIG. 17 is a diagram showing an example of a screen in the first embodiment.

FIG. 18 is a diagram showing an example of a screen in the first embodiment.

FIG. 19 is a schematic external view of a computer system in the first embodiment.

FIG. 20 is a block diagram of the computer system in the first embodiment.

### DETAILED DESCRIPTION OF THE INVENTION

Hereafter, embodiments of an information processing device and other configurations will be explained with reference to the drawings. The repeated explanation of the components denoted with the same reference numerals may be omitted in the embodiments since the operations are the same.

### First Embodiment

### <Outline of First Embodiment>

The present embodiment explains an information processing device for providing videos of a location corresponding to a received inquiry at a plurality of points in time. The inquiry includes, for example, location information, time information, weather information and the like. The videos at the plurality of points in time are, for example, a current video and a past video. Note that the video may also be called an image.

The present embodiment also explains an information processing device for also providing future information of the location corresponding to the received inquiry. Note that the future information is, for example, a predicted weather in the future or event information planned to be held in the future.

The present embodiment also explains an information processing device for providing videos at the location related to the location corresponding to the inquiry.

The present embodiment further explains a user terminal for obtaining videos of the location identified by the location information at a plurality of points in time by receiving the inquiry including the location information and transmitting the inquiry to the information processing device.

In the present embodiment, the fact that information X is associated with the information Y means that the information Y can be obtained from the information X or that the information X can be obtained from the information Y. The information X may be associated with the information Y in any manner. The information X and the information Y may be linked with each other or may be in the same buffer. The information X may be included in the information Y. The information Y may be included in the information X.

### <Outline of Information System A>

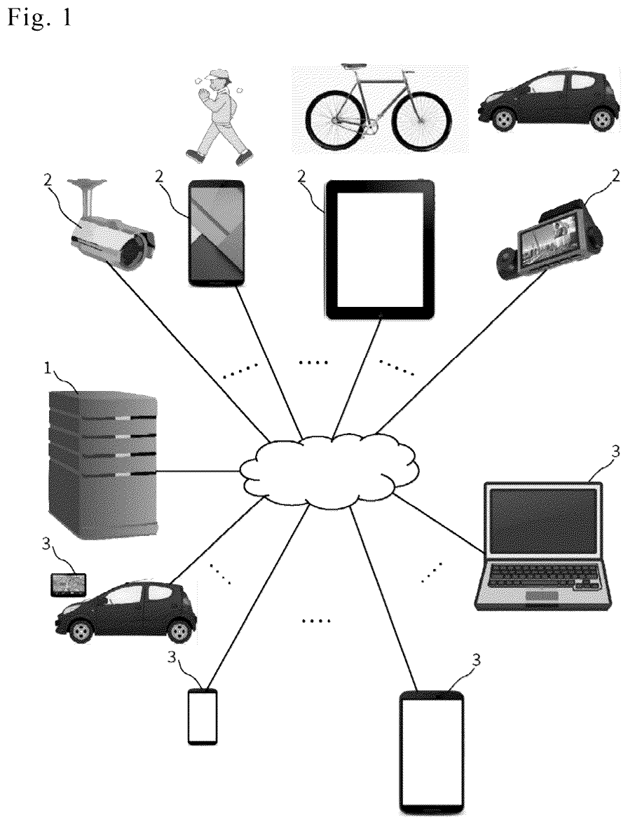

FIG. 1 is a schematic diagram of an information system A in the present embodiment. The information system A includes an information processing device 1, one or a plurality of providing terminals 2 and one or a plurality of user terminals 3.

The information processing device 1 is a device for providing the videos captured by the providing terminals 2 to the user terminals 3. The information processing device 1 is normally a server for providing the videos to the user terminals 3. The information processing device 1 is a cloud server or an application service provider (ASP) server, for example. The type of the information processing device 1 is not limited. The information processing device 1 may be a device included in a blockchain.

In the present specification, the interval of a plurality of still images included in the video is not limited. The video includes 60 frames per second or 30 frames per second, for example. However, the video may be a set of a plurality of still images captured at an interval equal to or longer than a predetermined time (e.g., one minute) or a set of a plurality of still images captured when a predetermined condition is satisfied. The still image may also be called a field or a frame.

The providing terminal 2 is the terminal for providing the videos. The providing terminal 2 is normally the device for transmitting the captured video to the information processing device 1. The providing terminal 2 is, for example, a mobile terminal or a fixed terminal. The mobile terminal is the terminal installed in a movable body to capture videos. The mobile terminal is, for example, a smartphone, a tablet terminal, a camera with a communication function, a glasses with a camera, a smartwatch with a camera or a drive recorder. The type of the mobile terminal is not limited. The installation normally means the condition where something is fastened. However, it is also possible to consider that the installation includes the situation where something is contacted or held. The movable body is an object that moves. The movable body is, for example, an automobile, a motorcycle, a bicycle or a living thing. The living thing is normally a human. However, the living thing may be other living things. The fixed terminal is the terminal that is installed at a fixed position to capture videos. The fixed terminal is normally a terminal fixed to a real estate or a road pole. The fixed terminal is, for example, a so-called surveillance camera or a street view camera.

The user terminal 3 is a terminal used by a user. The user terminal 3 is, for example, the device for receiving the inquiry and outputting an image of a location corresponding to the inquiry at a plurality of points in time. The user is a person who views the video or a person who requires the video. The user terminal 3 may also have the function of the providing terminal 2. Namely, the user terminal 3 may be the terminal of the user providing the video. The user terminal 3 is, for example, a smartphone, a tablet terminal, a so-called personal computer, a navigation terminal or the like. The type of the user terminal 3 is not limited.

The information processing device 1 and each of one or more providing terminals 2 can generally communicate with each other through a network such as the Internet. The information processing device 1 and each of one or more user terminals 3 can generally communicate with each other through a network such as the Internet.

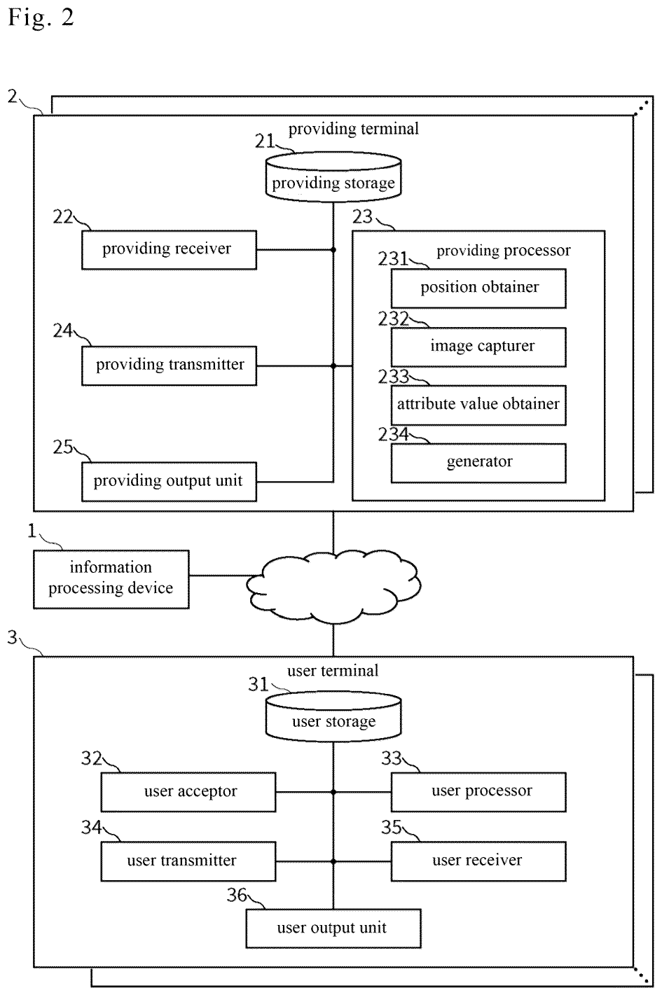

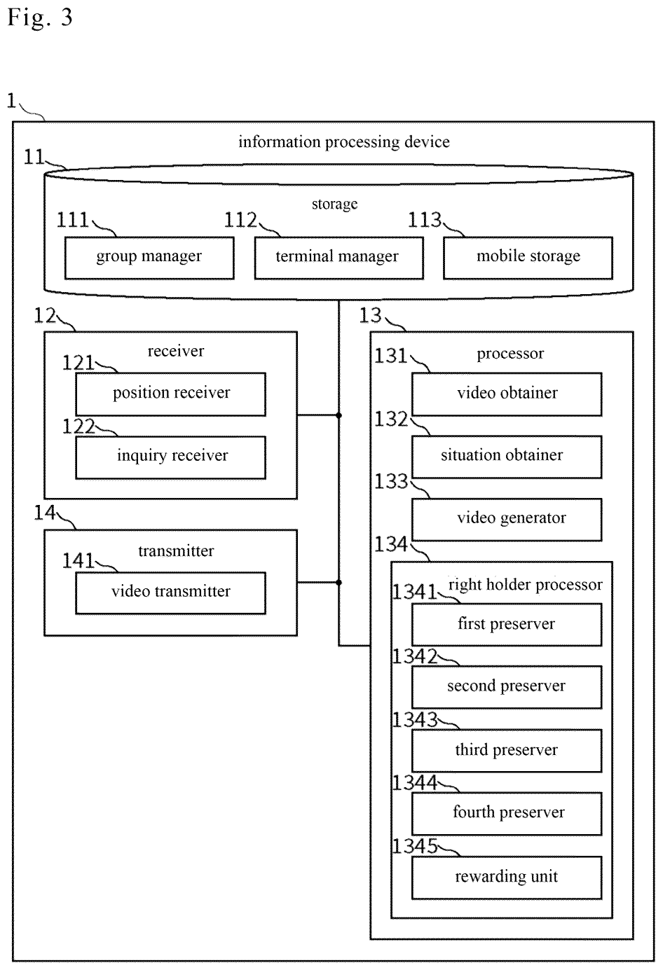

FIG. 2 is a block diagram of the information system A in the present embodiment. FIG. 3 is a block diagram of the information processing device 1.

The information processing device 1 includes a storage (storage unit) 11, a receiver (reception unit) 12, a processor (processing unit) 13 and a transmitter (transmission unit) 14. The storage 11 includes a group manager (group management unit) 111, a terminal manager (terminal management unit) 112 and a mobile storage (mobile management unit) 113. The receiver 12 includes a position receiver (position reception unit) 121 and an inquiry receiver (inquiry reception unit) 12. The processor 13 includes a video obtainer (video obtaining unit) 131, a situation obtainer (situation obtaining unit) 132, a screen generator (screen generation unit) 133 and a right holder processor (right holder processing unit) 134. The right holder processor 134 includes a first preserver (first preservation unit) 1341, a second preserver (second preservation unit) 1342, a third preserver (third preservation unit) 1343, a fourth preserver (fourth preservation unit) 1344 and a rewarding unit 1345. The transmitter 14 includes a screen transmitter (screen transmission unit) 141.

The providing terminal 2 includes a providing storage (providing storage unit) 21, a providing receiver (providing reception unit) 22, a providing processor (providing processing unit) 23, a providing transmitter (providing transmission unit) 24 and a providing output unit 25. The providing processor 23 includes a position obtainer (position obtaining unit) 231, an image capturer (image capturing unit) 232, an attribute value obtainer (attribute value obtaining unit) 233 and a generator (generation unit) 234.

The user terminal 3 includes a user storage (user storage unit) 31, a user acceptor (user acceptance unit) 32, a user processor (user processing unit) 33, a user transmitter (user transmission unit) 34, a user receiver (user reception unit) 35 and a user output unit 36.

### <Detail of Components of Information Processing Device 1>

The storage 11 stores various kinds of information. The various kinds of information are, for example, the later-described group information, the later-described terminal information, a video, one or a plurality of attribute values which are associated with the video, and map information.

The video attribute value is, for example, an attribute value of the video. The attribute value of the video is, for example, an environment information. The environment information is the information about the environment where the video is captured. The environment information is, for example, the later described positional information, time information, weather information, temperature information, season information or location identifier. The time information is the information for identifying the time. The time information is normally the information for identifying the time when the video is captured. The time when the video is captured may be the time around the time when the video is captured. The accuracy is not required for the time when the video is captured. The time information is, for example, a time, a set of year, month, day and hour, a set of year, month, day, hour and minute, a set of year, month, day, hour, minute and second, a set of year, month and day, a set of month and day or day. Namely, the time information may indicate the time with any granularity. The weather information is the information for identifying the weather at the location (or region) where the video is captured and at the time when the video is captured. The weather information is, for example, “sunny,” “rainy,” “snowy” or “cloudy.” The temperature information is the information for identifying a temperature at the location where the video is captured and at the time when the video is captured. The temperature information is, for example, “25 degrees” or “30 degrees or higher.” The season information is the information for identifying the season at the location where the video is captured and at the time when the video is captured. The season information is, for example, “spring,” “summer,” “early summer” or “winter.” A road attribute value is the attribute value of the road on which the providing terminal 2 travels.

The map information is used, for example, for obtaining the location identifier corresponding to the positional information. The map information is, for example, KIWI format. However, the data structure is not limited. The positional information is the information for identifying the position. The positional information is normally a set of a latitude and a longitude or a set of a latitude, a longitude and an altitude.

The location identifier is the information for identifying the location. The location identifier is, for example, the name of the location or the identification (ID) of the location.

The group manager 111 stores one or a plurality of group information. The group information is the information for identifying a plurality of related locations. The group information includes a plurality of related location information. The location information is the information for identifying the location. The location information is normally the location identifier or the positional information.

The terminal manager 112 stores one or a plurality of terminal information. The terminal information is the information related to the providing terminal 2. The terminal information here normally includes a terminal identifier which is the identifier of the providing terminal 2 and the terminal communication information. The terminal information includes, for example, an area identifier. The area identifier is the information for identifying the area. The area identifier is, for example, an area name or an identification (ID). The area includes one or a plurality of locations. The terminal information is, for example, the latest positional information when the providing terminal 2 is the mobile terminal. The terminal information includes, for example, the positional information indicating the position at which the providing terminal 2 is fixed as the fixed terminal. The terminal information is associated with the providing terminal 2. The terminal information of the terminal manager 112 is accumulated by transmitting the terminal communication information or the like from the providing terminal 2 when the providing terminal 2 is able to transmit the video, for example. The terminal information includes, for example, a keyword. The keyword is a term corresponding to the location at which the providing terminal 2 exists. The keyword is, for example, the term symbolizing the video captured by the providing terminal 2.

The terminal identifier is the information for identifying the providing terminal 2. The terminal identifier may be a right holder identifier for identifying a right holder which is a user of the providing terminal 2. The terminal identifier is, for example, an identification (ID) of the providing terminal 2, a user identifier of the user of the providing terminal 2, a name of the providing terminal 2, an IP address of the providing terminal 2 or a media access control (MAC) address of the providing terminal 2.

The right holder is a person having any right about the video captured by the providing terminal 2. The right holder is, for example, an owner of the video, a copyright holder of the video, an owner of the providing terminal 2 capturing the video or an authority with disposal rights of the video. The right holder is, for example, an initial right holder of the video. Although the right holder is normally the owner of the providing terminal 2, the right holder may be any person who has the right of the video captured by the providing terminal 2.

The right holder identifier may be the terminal identifier. The right holder identifier is, for example, an identification (ID) of the right holder, a name of the right holder, a mail address of the right holder or a telephone number of the right holder. The ID of the right holder is, for example, a user identifier.

The terminal communication information is the information for communicating with the providing terminal 2. The terminal communication information is, for example, an IP address of the providing terminal 2, a media access control (MAC) address of the providing terminal 2 or an identification (ID) of a communication application installed in the providing terminal 2.

The mobile storage 113 stores the video. The video is transmitted by the providing terminal 2. The video is associated with the right holder identifier, for example. The video is associated with one or more attribute values, for example. The attribute value is, for example, the area identifier, the location information (positional information or location identifier), the time information, the weather information or one or a plurality of keywords.

The receiver 12 receives various kinds of information and instructions. The various kinds of information and instructions are, for example, the positional information, the later described inquiry, the video or the video associated with one or more attribute values. Note that the video associated with one or more attribute values is appropriately referred to as an additional video. Note that the video is the concept including the additional video.

The position receiver 121 receives the positional information from each of one or a plurality of providing terminals 2. Note that the providing terminal 2 transmitting the positional information is normally the mobile terminal. In addition, each of the providing terminals 2 is the terminal capable of transmitting the video. The terminal capable of transmitting the video is, for example, the terminal currently capturing the video. However, the terminal capable of transmitting the video may be the terminal starting to capture the video when the instruction is received from the information processing device 1. The position receiver 121 normally receives the positional information from each of a plurality of providing terminals 2 continuously. To receive the positional information continuously means to receive it two or more times. For example, to receive the positional information continuously may be to receive it always, periodically or irregularly (two or more times).

The inquiry receiver 122 receives the inquiry from each of one or a plurality of user terminals 3. It can be said that the inquiry is the request for transmitting the screen based on the video at a predetermined location. The inquiry includes the location information. The inquiry preferably includes the location information, the time information and the weather information. The inquiry may include one or a plurality of keywords. The inquiry may include a plurality of time information.

The processor 13 performs various kinds of processes. For example, the various kinds of processes are performed by the video obtainer 131, the situation obtainer 132, the screen generator 133 or the right holder processor 134.

The processor 13 may perform the same process as the later described attribute value obtainer 233, obtain one or more attribute values and associate the one or more attribute values with the video when the receiver 12 receives the video from the providing terminal 2, for example.

The video obtainer 131 obtains the video of the location identified by the location information included in the inquiry at a plurality of points in time. The video at a plurality of points in time preferably includes the current video and the past video of the location identified by the location information.

Note that the video obtainer 131 may obtain the video of the location identified by the location information included in the inquiry at one point in time. The video at one point in time is preferably the past video. For example, the video obtainer 131 obtains one past video of the location identified by the location information included in the inquiry where the one past video corresponds to the predicted weather of a future date included in the inquiry.

For example, the video obtainer 131 obtains the video from the mobile storage 113. For example, the video obtainer 131 obtains the video from the providing terminal 2. For example, the video obtainer 131 obtains the video from the mobile storage 113 and the providing terminal 2. Note that the video obtainer 131 is normally included in the information processing device 1. However, the device receiving the video from the providing terminal 2 may be one or a plurality of devices other than the information processing device 1.

The video obtainer 131 obtains the video of the location identified by the location information included in the inquiry where the video includes the video of a plurality of locations corresponding to the weather information for identifying the future weather of the location. The video corresponding to the weather information is normally the video paired with the weather information satisfying the weather information. However, the video corresponding to the weather information may be the video paired with the weather information approximating the weather information. In the above described case, two or more weather information approximating each other is managed in the storage 11.

For example, the video obtainer 131 obtains the location information included in the inquiry. Then, the video obtainer 131 obtains, for example, the weather information, which is the information of the future weather forecast of the location information, from a not-illustrated server (hereafter, referred to as “weather server”) of the weather forecast. Then, the video obtainer 131 obtains, for example, the video corresponding to the location information and the weather information from the mobile storage 113. Note that the above described video is the past video captured at the location identified by the location information at the time when the weather is the same as the weather identified by the weather information. Note that the future in the future weather forecast may be included in the inquiry or may be preliminarily determined. The future is, for example, four hours later or the current time of tomorrow.

For example, the video obtainer 131 obtains the location information included in the inquiry. Then, the video obtainer 131 obtains, for example, the weather information, which is the information of the future weather forecast of the location information, from the weather server. In addition, the video obtainer 131 obtains, for example, today's date (month and date) from a not-illustrated clock. Then, the video obtainer 131 obtains, for example, the video corresponding to the location information, the weather information and the date from the mobile storage 113. Note that the above described video is the past video captured at the location identified by the location information, on the same date or the close date as the above described date and the time when the weather is the same as the weather identified by the weather information. The close date normally means that the two dates are within a predetermined period.

The video obtainer 131 obtains, for example, the video satisfying the location information, the time information and the weather information included in the received inquiry from the mobile storage 113 storing the videos associated with three or more attribute values including the location information, the time information and the weather information.

For example, the video obtainer 131 refers to the group manager 111 storing the group information including a plurality of location information and obtains a plurality of videos including the videos of the location identified by the other location information which is paired with the location information included in the received inquiry. For example, the video obtainer 131 may receive the video of the other location from the providing terminal 2 or the mobile storage 113.

When the video obtainer 131 cannot receive the video of the location identified by the location information included in the received inquiry, the video obtainer 131 preferably obtains the video of the location identified by the other location information included in the group information including the location information.

When the video obtainer 131 obtains the video currently captured by the providing terminal 2, the video obtainer 131 determines the providing terminal 2 obtaining the video in any one of the following methods (1) (2), for example.

(1) when the Video Obtainer 131 Determines the Providing Terminal 2 Transmitting the Video.

The video obtainer 131 transmits the transmission instruction of the video to the providing terminal 2 located at the location identified by the location information included in the inquiry and receives the video from the providing terminal 2 when the transmission instruction is transmitted. In the above described case, the video obtainer 131 operates in the following manner. Note that the transmission instruction is the instruction of transmitting the video.

Namely, the video obtainer 131 determines the providing terminal 2 located at the location identified by the location information included in the inquiry using the positional information of the providing terminal 2 received by the position receiver 121. Then, the video obtainer 131 transmits the transmission instruction to the determined providing terminal 2. Then, the video obtainer 131 receives the video from each of a plurality of providing terminals 2 transmitting the transmission instruction.

(2) when the Providing Terminal 2 Determines Whether or not to Transmit the Video.

The video obtainer 131 transmits the inquiry to a plurality of providing terminals 2. Here, the plurality of providing terminals 2 is a plurality of providing terminals 2 capable of transmitting the video. Here, the plurality of providing terminals 2 is normally all providing terminals 2 capable of transmitting the video. Here, the plurality of providing terminals 2 is, for example, a plurality of providing terminals 2 managed by the terminal manager 112.

The inquiry transmitted to the providing terminal 2 may be the same information as the received inquiry or the different information.

When the inquiry is transmitted, the video obtainer 131 receives the video from the providing terminal 2 which is determined to satisfy the location information included in the inquiry.

The situation obtainer 132 obtains the situation information of the location identified by the location information included in the inquiry. The situation information is the information for identifying the situation of the location. The situation information is, for example, the information for identifying the future situation of the location identified by the location information. When the situation information is the information for identifying the future situation, the situation information may be referred to as the future information. The situation information is, for example, the current situation of the location identified by the location information or the information for identifying the situation of the video. When the situation information is the current situation or the information for identifying the situation of the video, the situation information may be referred to as the current information. The future information is, for example, the weather information indicating the predicted weather and the event information held in the future. The current information is, for example, the information which can be detected from the captured videos. The information which can be detected from the captured videos is, for example, the analysis result of the still images included in the video. The analysis result is, for example, the information indicating the brightness and darkness of the video and the name of the object in the still images. The information indicating the brightness and darkness of the video may be the flag information which is the information that can take either the value “bright” or “dark” in two stages, the brightness level which is the information that can take any value across three or more stages of brightness/darkness or the brightness. For example, the situation obtainer 132 obtains the brightness of the still image included in the video and obtains the flag information or the brightness level from the brightness. For example, the situation obtainer 132 obtains the flag information “bright” when the brightness is a predetermined value of more, and obtains the flag information “dark” when the brightness is less than the predetermined value. For example, the situation obtainer 132 refers to the corresponding table including three or more corresponding information including the range of the brightness and the brightness level and obtains the brightness level paired with the obtained brightness. For example, the situation obtainer 132 performs the image recognition process to the still images included in the video and obtains the name of the captured objects in the video.

The screen generator 133 generates the screen based on a plurality of videos obtained by the video obtainer 131. The above described screen preferably includes a plurality of videos. The above described screen preferably includes all videos obtained by the video obtainer 131. However, the above described screen may be the screen including a thumbnail image based on one frame constituting each of a plurality of videos or may be the screen including a part (e.g., one) of a plurality of videos and the thumbnail image based on one frame constituting each of a plurality of videos. It is preferred that one or more videos are included in a part of the area (window) in the screen. In addition, to generate the screen is to obtain the screen information which is the base for displaying the screen. The screen information is described, for example, by HTML, XML or the like. However, the format is not limited.

The screen generator 133 may generate the screen based on one video obtained by the video obtainer 131.

The screen generator 133 preferably generates the screen including one, two or more situation information obtained by the situation obtainer 132.

The screen generator 133 preferably includes one or more attribute values of each of a plurality of videos obtained by the video obtainer 131.

The screen generator 133 preferably generates the screen including a plurality of videos in chronological order. The chronological order may be new-to-old order or old-to-new order.

The right holder processor 134 performs the right holder process. The right holder process is the process about the right holder identified by the right holder identifier associated with the video. Note that the video here is, for example, the video obtained by the video obtainer 131. The video here is, for example, the video received by the receiver 12. The video here is, for example, the video which is the source of the screen.

For example, the right holder processor 134 performs the right holder process which is the process related to the right holder identified by the right holder identifier associated with each of a plurality of videos corresponding to the screen when the screen transmitter 141 transmits the screen. The right holder process is, for example, the later-described first preservation process, the later-described second preservation process, the later-described third preservation process, the later-described fourth preservation process and the later-described rewarding process.

Note that the right holder identifier associated with the video is, for example, the right holder identifier corresponding to the providing terminal 2 transmitting the video or the user identifier of the user terminal 3 to which the video is transmitted. The user of the user terminal 3 is the user transmitting the inquiry.

The first preserver 1341 performs the first preservation process of accumulating the video received by the receiver 12 while being associated with the attribute value set associated with the video. Note that the attribute value set includes one or a plurality of attribute values. For example, the first preserver 1341 accumulates the video in a blockchain.

The second preserver 1342 performs the second preservation process of accumulating the video received by the receiver 12 while being associated with the right holder identifier corresponding to the video. For example, the second preserver 1342 accumulates the video in the blockchain. Note that the right holder identifier here is, for example, the terminal identifier of the providing terminal 2.

The third preserver 1343 accumulates the right holder identifier for identifying the user of the user terminal 3 while being associated with the video. For example, the third preserver 1343 accumulates the right holder identifier in the storage 11 or the blockchain. The third preserver 1343 may accumulate a plurality of videos received by the receiver 12 while being associated with the right holder identifier for identifying the user of the user terminal 3. The third preserver 1343 may accumulate the screens (videos in screens) transmitted by the screen transmitter 141 and continued in time series manner while being paired with the right holder identifier. Note that the right holder identifier here is normally the user identifier of the user terminal 3.

Note that the destination in which the video is accumulated is, for example, the storage 11. However, the destination may be the other devices or the other devices constituting the blockchain.

The fourth preserver 1344 performs the fourth preservation process of accumulating a preservation information. The preservation information includes the access information for accessing the accumulated videos. The order of performing the accumulation of the video and performing the fourth preservation process for the preservation information corresponding to the video is not limited.

For example, the fourth preserver 1344 performs the fourth preservation process of accumulating the preservation information including the access information for accessing a plurality of videos obtained by the video obtainer 131. For example, the fourth preserver 1344 performs the fourth preservation process of accumulating the preservation information including the access information for accessing the videos of the screen transmitted from the screen transmitter 141 to the user terminal 3.

Note that the fourth preserver 1344 preferably accumulates the preservation information in the blockchain. Namely, the fourth preserver 1344 preferably accumulates the preservation information in a distributed ledger in the blockchain. The fourth preserver 1344 preferably registers the preservation information as an NFT (non-fungible token). The fourth preserver 1344 preferably registers the preservation information in a distributed file system in an IPFS (Inter Planetary File System) network.

The preservation information is the information for retaining the originality of the video. The preservation information may be referred to as the headline information of the video. The preservation information is, for example, the access information and the attribute value set. The preservation information preferably includes, for example, one or a plurality of right holder identifiers. When the preservation information includes a plurality of right holder identifiers, the video may be shared by right holders and the plurality of right holder identifiers may be right holder history information. The right holder history information is a set of right holder identifiers and information indicating the history of right holder changes. The fourth preservation process guarantees the originality of the preservation information of the registered video (or video of screen). The guarantee of the originality of the preservation information also guarantees the originality of the video corresponding to the preservation information. Note that the access information is the information for accessing the video. The access information is the information for identifying the destination in which the video is accumulated. The access information is, for example, URL and URI.

The rewarding unit 1345 performs the rewarding process of providing the reward to each of the right holders identified by the right holder identifier which is associated with the video obtained by the video obtainer 131. Note that the above described right holder identifier is, for example, an owner of the providing terminal 2.

The rewarding process is the process of providing the reward. For example, the rewarding process is the process of increasing points managed in a manner paired with each of one or a plurality of right holder identifiers associated with the video. For example, the rewarding process is the process of paying money to the right holder identified by each of one or a plurality of right holder identifiers associated with the video. For example, the rewarding process is the process of transmitting the video or other contents to the user terminal 3 of the right holder identified by each of one or a plurality of right holder identifiers associated with the video. The rewarding process may be any processes of providing a merit to the right holder identified by each of one or a plurality of right holder identifiers associated with the video. The content of the rewarding process is not limited. The reward may be provided in any form, including money, points, products, and contents. The content of the reward is not limited.

The rewarding unit 1345 preferably performs the rewarding process of obtaining one or a plurality of attribute values of the video corresponding to the screen transmitted by the screen transmitter 141, determining the reward to the right holder of the video and providing the reward.

Here, one or more attribute values are, for example, the data amount of the video, the time of the video, the number of frames of the video and the resolution of the video.

The rewarding unit 1345 preferably obtains a reward amount corresponding to a service identifier for identifying the service performed on the target video and performs the rewarding process which is the process of providing the reward corresponding to the reward amount. Note that the service identifier is, for example, “viewing” and “purchasing.” In the above described case, the storage 11 stores the reward amount corresponding to the service identifier or the information for determining the reward amount corresponding to the service identifier.

For example, the rewarding unit 1345 obtains the reward amount and performs the rewarding process which is the process of providing the reward corresponding to the reward amount using one or a plurality of information of one or a plurality of attribute values and service identifiers. In the above described case, an arithmetic expression or a corresponding table corresponding to each of a plurality of service identifiers is stored in the storage 11, for example. The arithmetic expression is the expression for calculating the reward amount using one or a plurality of attribute values as parameters. The corresponding table is the table including a plurality of correspondence information for managing the reward amount corresponding to one or a plurality of attribute values.

The rewarding unit 1345 normally performs the process of causing the user that has enjoyed the service relevant to the target video to pay the reward. The process of causing the user to pay the reward is, for example, the process of causing the user to pay the obtained reward amount. The process of causing the user to pay the reward is, for example, the process of causing the user to pay the obtained reward amount and the profit obtained by the management side of the information processing device 1. The process of causing the user to pay the reward is, for example, the process of reducing the points corresponding to the user receiving the service or the settlement process using the credit card number of the corresponding user. Note that the user receiving the service is normally the user of the user terminal 3.

The transmitter 14 transmits various kinds of information and instructions. The various kinds of information and instructions are, for example, the screen.

The video transmitter 141 transmits the screen obtained by the screen generator 133 to the user terminal 3 from which the inquiry is transmitted. The screen transmitter 141 normally transmits the screen including the video captured at a predetermined location at a plurality of points in time to the user terminal 3. However, the screen transmitter 141 may transmit the screen for reproducing the video in the user terminal 3 and transmit the video corresponding to the inquiry when the instruction is received from the user terminal 3. The above described case is also the transmission of the screen based on the video.

### <Detail of Components of Providing Terminal 2>

The providing storage 21 stores various kinds of information. The various kinds of information are, for example, the video, the attribute value set, the right holder identifier, the camera attribute value and the map information. The camera attribute value is the attribute value of the camera. The camera attribute value is, for example, an angle of view, a direction information and a resolution.

For example, one or more attribute values included in the attribute value set is associated with one or more still images included in the video. One or more attribute values may be associated with all still images, associated with a part of the still images, or associated with a plurality of still images.

The providing receiver 22 receives various kinds of information and instructions. The various kinds of information and instructions are, for example, the transmission instruction or the inquiry.

The providing processor 23 performs various kinds of processes. For example, the various kinds of processes are performed by the position obtainer 231, the image capturer 232, the attribute value obtainer 233 and the generator 234.

The position obtainer 231 obtains the positional information. The position obtainer 231 normally obtains the positional information for identifying the current position of the providing terminal 2. The position obtainer 231 obtains the positional information by a GPS receiver, for example. However, the method and the algorithm of obtaining the positional information by the position obtainer 231 are not limited.

The image capturer 232 captures the video. For example, the image capturer 232 captures the video during the movement of the providing terminal 2 which is the mobile terminal. Note that the positional information obtained by the position obtainer 231 is preferably associated with the captured video. One or more attribute values obtained by the later described attribute value obtainer 233 are preferably associated with the captured video.

The image capturer 232 preferably accumulates the captured video in the providing storage 21. The image capturer 232 preferably overwrites the area storing old video with new video when the storage capacity of the providing storage 21 for accumulating the video is limited. Namely, the providing storage 21 preferably has a ring buffer structure.

For example, the image capturer 232 may start capturing the video when the transmission instruction is received. For example, the image capturer 232 may start capturing the video when a location condition is determined to be satisfied with respect to the received inquiry. For example, the image capturer 232 starts capturing the video when the input of the capturing instruction is received from the user.

Note that the location condition means that two locations are the same location or are close to each other. For example, the location condition means that the location indicated by the positional information obtained by the position obtainer 231 and the location identified by the location information included in the inquiry are the same, or the distance between the location indicated by the positional information obtained by the position obtainer 231 and the location identified by the location information included in the inquiry is within a threshold value or less than the threshold value.

The attribute value obtainer 233 obtains one or more camera attribute values including the direction information indicating the direction capturing the image by the image capturer 232. The attribute value obtainer 233 preferably obtains one or a plurality of attribute values including the camera attribute value.

The attribute value obtainer 233 obtains, for example, one or more attribute values. The one or a plurality of attribute values can be referred to as the attribute value set. The attribute value obtainer 233 obtains, for example, the time information from a not-illustrated clock during image capturing. The attribute value obtainer 233 obtains, for example, the time information continuously, at predetermined intervals, or when the obtaining condition is satisfied. The attribute value obtainer 233 obtains, for example, the time information from a not-illustrated clock during image capturing, and obtains the season information corresponding to the time information. The attribute value obtainer 233 obtains, for example, the weather information corresponding to the positional information from the weather server. The attribute value obtainer 233 obtains, for example, the weather information continuously, at predetermined intervals, or when the obtaining condition is satisfied. The attribute value obtainer 233 obtains, for example, the temperature information during image capturing. The mobile processor 23 obtains, for example, the temperature information corresponding to the positional information from a not-illustrated server. The mobile processor 23 obtains, for example, the temperature information from a temperature sensor installed in the movable body. The mobile processor 23 obtains, for example, the temperature information continuously, at predetermined intervals, or when the obtaining condition is satisfied. Note that the obtaining condition is, for example, when the analysis result of the video satisfies a predetermined condition.

The attribute value obtainer 233 obtains, for example, the location identifier corresponding to the positional information obtained by the position obtainer 231 and associates the location identifier with the video. For example, the attribute value obtainer 233 obtains the location identifier corresponding to the positional information obtained by the position obtainer 231 and satisfying a predetermined condition from the map information and associates the location identifier with the video. The predetermined condition is, for example, the condition that the location identifier is a predetermined kind of location identifier (e.g., location name, station name).

Note that the operation of associating the location identifier with the video may be the operation of associating the location identifier with the frame constituting the video or the operation of associating the location identifier with the entire video.

The attribute value obtainer 233 obtains, for example, one or more tags corresponding to the video captured by the image capturer 232 and associates the one or more tags with the video. Note that it can be said that the tag is also the attribute value.

For example, the attribute value obtainer 233 analyzes the video captured by the image capturer 232 and obtains one or more tags corresponding to the video.

For example, the attribute value obtainer 233 obtains one or more tags using one or a plurality of movable body attribute values obtained during image capturing by the image capturer 232. The movable body attribute value is, for example, CAN data.

For example, the attribute value obtainer 233 determines one or more still images satisfying the video tag condition and obtains the tag paired with the video tag condition. The attribute value obtainer 233 may associate the tag with one or more still images. Note that the still images are frames included in the video.

For example, when the video tag conditions are “the number of automobiles at a front-rear interval within a threshold value is equal to or greater than a threshold value and the speed of the automobiles is equal to or lower than a threshold value” and the tag paired with the video tag condition is “traffic jam,” the tag attribute value obtainer 233 analyzes the frames included in the video, identifies a plurality of automobiles and obtains the interval between each pair of the plurality of automobiles. The attribute value obtainer 233 obtains the number of automobiles at the interval within the threshold value. The attribute value obtainer 233 obtains the movement distance of one automobile in a plurality of frames and the frame rate, and obtains the speed of the automobile. The attribute value obtainer 233 determines whether or not the video tag condition is satisfied using the number of automobiles at the interval within the threshold value and the speed of the automobile. When the video tag condition is satisfied, the attribute value obtainer 233 obtains the tag of “traffic jam” paired with the video tag condition. The attribute value obtainer 233 may associate the tag of “traffic jam” with the analyzed frame of the analyzed video.

For example, the attribute value obtainer 233 determines one or more movable body attribute values satisfying the attribute value tag condition and obtains the tag paired with the attribute value tag condition. The attribute value obtainer 233 may associate the tag with the video paired with the one or more movable body attribute values.

For example, when the attribute value tag condition is “the travel at the speed lower than 30 km lasts for 10 minutes or longer and the rate of the travel duration at the speed lower than 30 km/h is 80% or higher” and the tag paired with the attribute value tag condition is “traffic jam,” the attribute value obtainer 233 detects the CAN data satisfying the attribute value tag condition using the history of the speed included in the CAN data associated with each field included in the video, obtains the tag of “traffic jam” paired with the attribute value tag condition, and associates the tag with the field associated with the CAN data. The CAN data associated with each field included in the video is the CAN data obtained at the same time as when the field is captured.

The generator 234 associates the obtained positional information with the video and obtains the additional video. For example, the generator 234 obtains the additional video in which one or more camera attribute values obtained by the attribute value obtainer 233 are also associated with the video. For example, the generator 234 obtains the additional video in which one or more attribute values obtained by the attribute value obtainer 233 are also associated with the video. The additional video normally includes the positional information.

The providing transmitter 24 transmits various kinds of information to the information processing device 1. The various kinds of information are, for example, the video and the additional video. The providing transmitter 24 may transmit the video obtained by the image capturer 232 continuously to the information processing device 1. In the above described case, the positional information and the time information are normally associated with the video.

For example, the providing transmitter 24 transmits the video obtained by the image capturer 232 to the information processing device 1 when the transmission instruction is received.

For example, the providing transmitter 24 transmits the video obtained by the image capturer 232 to the information processing device 1 when the location condition is determined to be satisfied with respect to the received inquiry.

The providing output unit 25 outputs various kinds of information. The various kinds of information are, for example, the video, the additional video and the attribute value set.

The output is the concept including the operation of displaying on a display, the operation of projecting with a projector, the operation of printing with a printer, the operation of outputting sound, the operation of transmitting to an external device, the operation of accumulating in a recording medium, and the operation of delivering a processed result to another processor or another program.

### <Detail of Components of User Terminal 3>

The user storage 31 stores various kinds of information. The various kinds of information are, for example, the user identifier, the video, the inquiry and the map information.

The user acceptor 32 accepts various kinds of instructions and information. The various kinds of instructions and information are, for example, the inquiry. The inquiry received by the user acceptor 32 includes, for example, the location information. The inquiry includes, for example, one or more kinds of information of the time information, the weather information and the keyword.

The acceptance is the concept including the acceptance of the information inputted from input devices such as a keyboard, a mouse and a touch panel, the acceptance of the information transmitted via a communication line with wired or wireless communication, and the acceptance of the information read from recording media such as an optical disk, a magnetic disk and a semiconductor memory.

The user acceptor 32 accepts, for example, the inquiry from the user. The above described inquiry is the instruction for obtaining the video at a predetermined location at a plurality of points in time. The inquiry accepted by the user may be only the button press or the selection of the menu item. Alternatively, the inquiry accepted by the user may include the input of the location information. It is preferred that the inquiry does not include the information for identifying all points of time of a plurality of videos to be outputted. However, the inquiry may include the information for identifying all points of time. Namely, it is preferred that an appropriate point of time is automatically obtained as the point of the time of the video to be outputted without being specified by the user.

The user processor 33 performs various kinds of processes. The various kinds of processes are, for example, the processes related to the data structure for transmitting various kinds of instructions and information received by the user acceptor 32. The various kinds of processes are, for example, the processes related to the structure of transmitting the information received by the user receiver 35.

The user processor 33 obtains, for example, the positional information of the user terminal 3. For example, the user processor 33 obtains the positional information of the user terminal 3 and obtains the location identifier paired with the positional information from the map information of the user storage 31 or the map information of a not-illustrated device.

For example, the user processor 33 generates the inquiry to be transmitted based on the inquiry from the user. For example, the user processor 33 adds the user identifier of the user storage 31 to the inquiry from the user to generate the inquiry to be transmitted. For example, the user processor 33 adds the user identifier of the user storage 31 and the obtained positional information or location identifier to the inquiry from the user to generate the inquiry to be transmitted.

The user transmitter 34 transmits various kinds of instructions and information to the information processing device 1. The various kinds of instructions and information are, for example, the inquiry or the instruction for transmitting a predetermined video.

The user receiver 35 receives the screen based on the video at a predetermined location identified by the location information included in the inquiry at a plurality of points in time when the inquiry is transmitted.

The user output unit 36 outputs the screen received by the user receiver 35. Note that the above described screen preferably includes the video at a predetermined location at a plurality of points in time.

The storage 11, the group manager 111, the terminal manager 112, the mobile storage 113, the providing storage 21 and the user storage 31 are preferably a nonvolatile recording medium. However, these storages may be a volatile recording medium.

The process of storing the information in the storage 11 or the like is not limited. For example, the information may be stored in the storage 11 or the like via a recording medium, the information transmitted via a communication line or the like may be stored in the storage 11 or the like, or the information inputted by an input device may be stored in the storage 11 or the like.

The receiver 12, the position receiver 121, the inquiry receiver 122, the providing receiver 22 and the user receiver 35 are normally implemented by a wireless or wired communication means. However, these receivers may be implemented by a means for receiving a broadcast.

The processor 13, the video obtainer 131, the situation obtainer 132, the screen generator 133, the right holder processor 134, the first preserver 1341, the second preserver 1342, the third preserver 1343, the fourth preserver 1344, the rewarding unit 1345, the providing processor 23, the attribute value obtainer 233, the generator 234 and the user processor 33 may normally be implemented by a processor, a memory or the like. The processing procedure of the processor 13 or the like is normally implemented by a software and the software is stored in a recording medium such as a read-only memory (ROM). However, the processing procedure may be implemented by a hardware (dedicated circuit). Note that the processor is a central processing unit (CPU), a microprocessor unit (MPU), a graphical processing unit (GPU) or the like. The type of the processor is not limited.

The transmitter 14, the screen transmitter 141, the providing transmitter 24 and the user transmitter 34 are normally implemented by a wireless or wired communication means. However, these transmitters may be implemented by a broadcast means.

The position obtainer 231 is achieved, for example, by a GPS receiver.

The image capturer 232 is achieved by a camera.

The providing output unit 25 and the user output unit 36 may or may not include an output device such as a display and a speaker. The providing output unit 25 may be implemented by a driver software of an output device or implemented by a driver software of an output device and the output device, for example.

The user acceptor 32 may be implemented by a device driver of an input device such as a touch panel and a keyboard or a control software of a menu screen, for example.

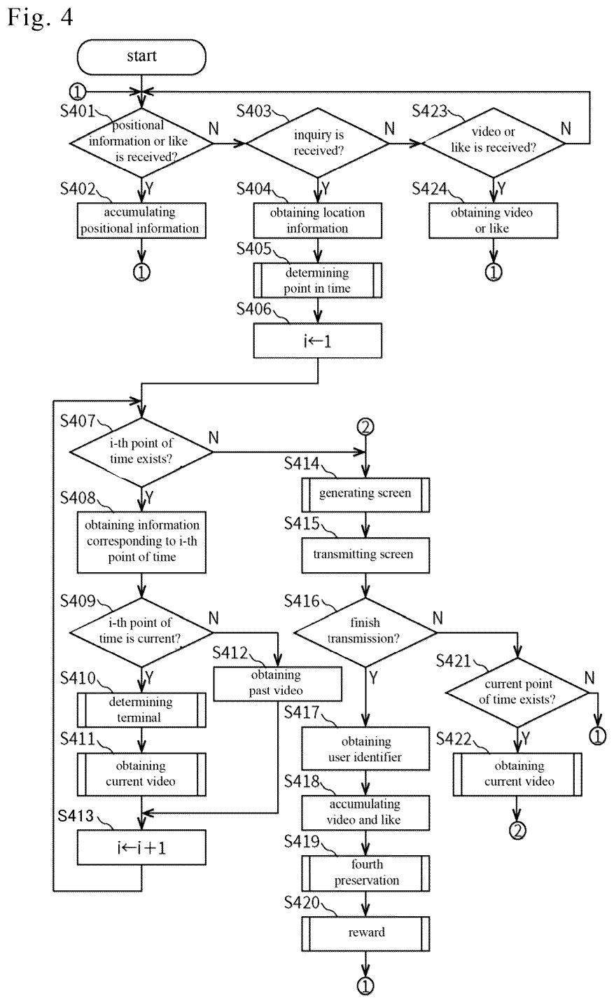

Then, the operation example of the information system A will be explained. First, the operation example of the information processing device 1 will be explained using the flowchart in FIG. 4.

(S401) The position receiver 121 determines whether or not the positional information and the like are received from the providing terminal 2. When the positional information and the like are received, the processing proceeds to S402. When the positional information and the like are not received, the processing proceeds to S403. Note that the positional information and the like are, for example, the positional information and the terminal identifier. The position receiver 121 may receive the location identifier instead of the positional information or in addition to the positional information.

(S402) The processor 13 accumulates the positional information and the like received in S401 in the terminal manager 112 while being associated with the terminal identifier. The processing returns to S401.

(S403) The inquiry receiver 122 determines whether or not the inquiry is received from the user terminal 3. When the inquiry is received, the processing proceeds to S404. When the inquiry is not received, the processing proceeds to S423. Note that the inquiry to be received is associated with the user identifier.

(S404) The video obtainer 131 obtains the location information included in the inquiry.

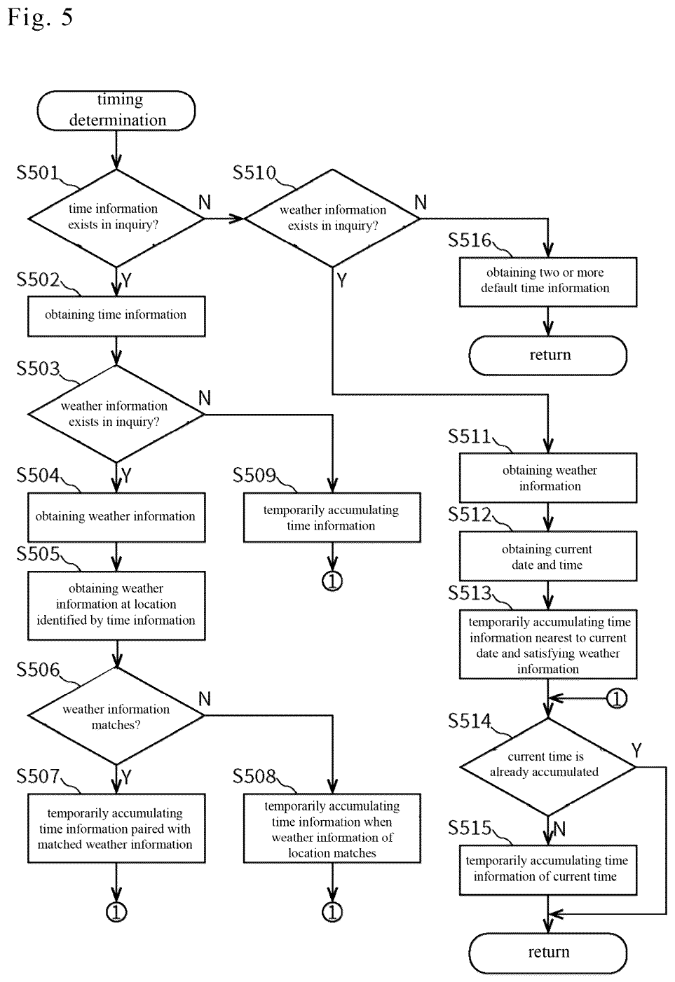

(S405) The video obtainer 131 determines a plurality of points in time of the video to be obtained in accordance with the inquiry. An example of the above described timing determination process will be explained using the flowchart in FIG. 5. Note that the video obtainer 131 obtains, for example, a time point information for identifying each of a plurality of points in time. The time point information is, for example, the time information.

(S406) The video obtainer 131 substitutes 1 for a counter i.

(S407) The video obtainer 131 determines whether or not the i-th point of time exists in a plurality of points in time determined in S405. When the i-th point of time exists, the processing proceeds to S408. When the i-th point of time does not exist, the processing proceeds to S414. Note that the video obtainer 131 determines whether or not the i-th time point information exists in the time point information obtained in S405, for example.

(S408) The video obtainer 131 obtains the i-th time point information. The video obtainer 131 obtains the location information included in the inquiry. The video obtainer 131 obtains the i-th condition including the i-th time point information and the location information. Note that the i-th condition may include one or more keywords included in the received inquiry.

(S409) The video obtainer 131 determines whether or not the i-th point of time is “current” point of time. When the i-th point of time is “current” point of time, the processing proceeds to S410. When the i-th point of time is not “current” point of time, the processing proceeds to S412.

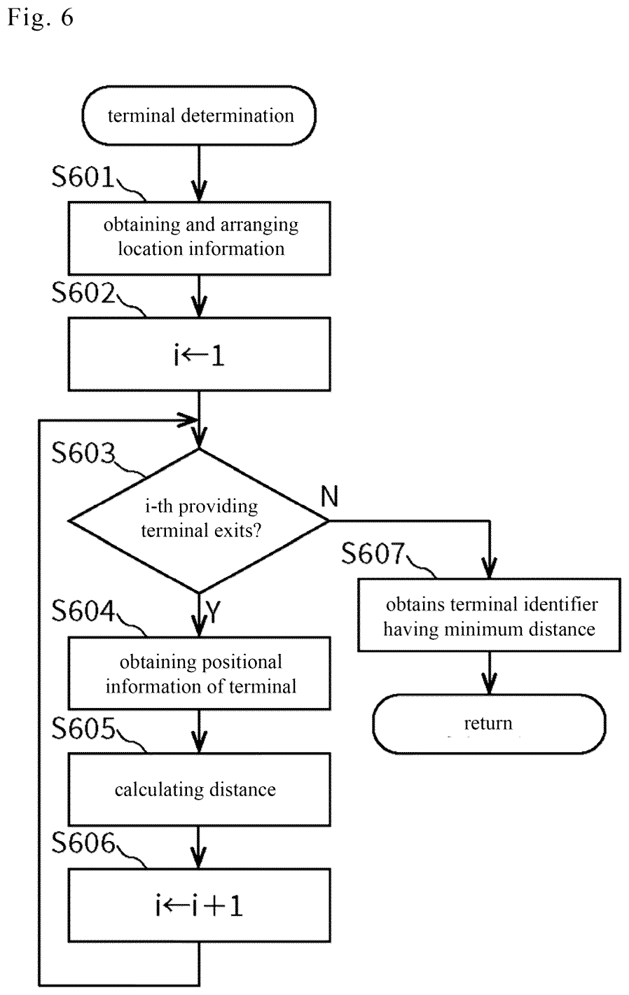

(S410) The video obtainer 131 determines the providing terminal 2 located at the location corresponding to the location information included in the condition obtained in S408. An example of the above described terminal determination process will be explained using the flowchart in FIG. 6.

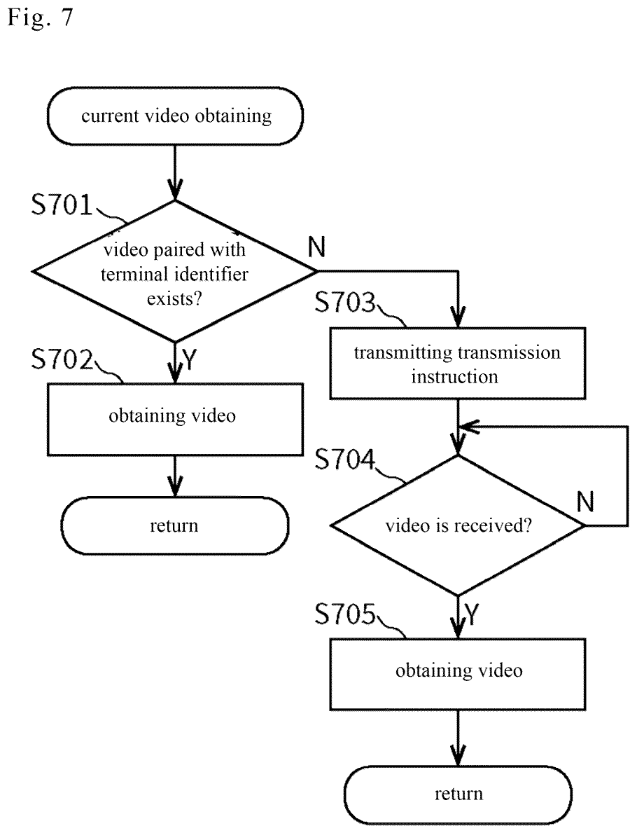

(S411) The video obtainer 131 obtains the current video obtained by the providing terminal 2 determined in S410. An example of the current video obtaining process will be explained using the flowchart in FIG. 7. Note that the current video is the video which is currently captured. In addition, a time delay has normally occurred between the timing when capturing the video and the timing when obtaining the video.

(S412) The video obtainer 131 obtains the video satisfying the i-th condition from the mobile storage 113. The above described video is the past video. Note that the past video is the video captured in the past.

(S413) The video obtainer 131 increments the counter i by 1. The processing returns to S407.

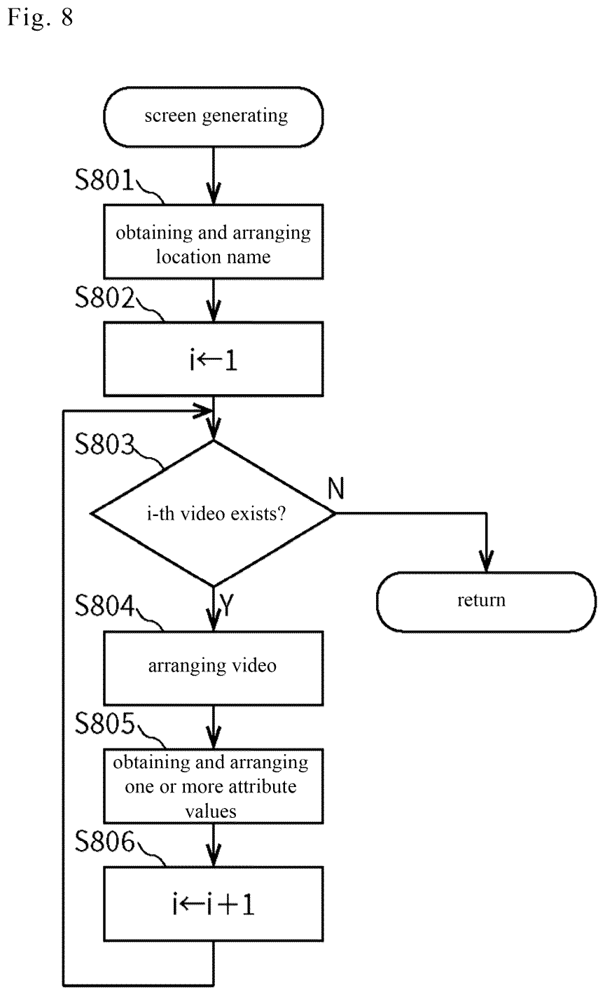

(S414) The screen generator 133 generates the screen based on a plurality of videos obtained by the video obtainer 131. An example of the above described screen generating process will be explained using the flowchart in FIG. 8.

(S415) The screen transmitter 141 transmits the screen generated in S414 to the user terminal 3 from which the inquiry is transmitted.

(S416) The processor 13 determines whether or not to finish the transmission of the screen. When the transmission will be finished, the processing proceeds to S417. When the transmission will not be finished, the processing returns to S421. The case of finishing the transmission of the screen is, for example, when the instruction of finishing the transmission is received from the user terminal 3.

(S417) The third preserver 1343 obtains the user identifier of the user terminal 3.

(S418) The third preserver 1343 accumulates the videos of the screen transmitted in S415 or a plurality of videos, which is the source of the screen, while being paired with the user identifier obtained in S417. By the above described operation, the right holder of the videos of the screen transmitted in S415 or a plurality of videos, which is the source of the screen, is set to the user identified by the user identifier. Namely, the above described user identifier is the right holder identifier.

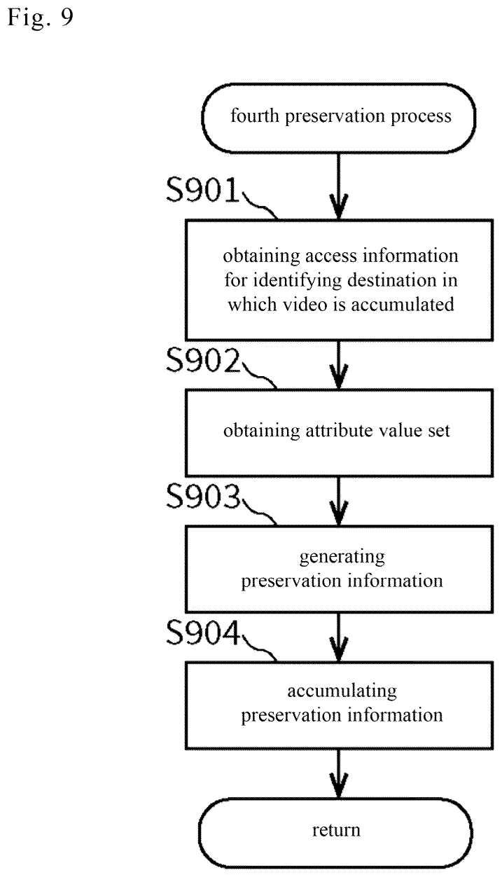

(S419) The fourth preserver 1344 performs the fourth preservation process. An example of the above described fourth preservation process will be explained using the flowchart in FIG. 9.

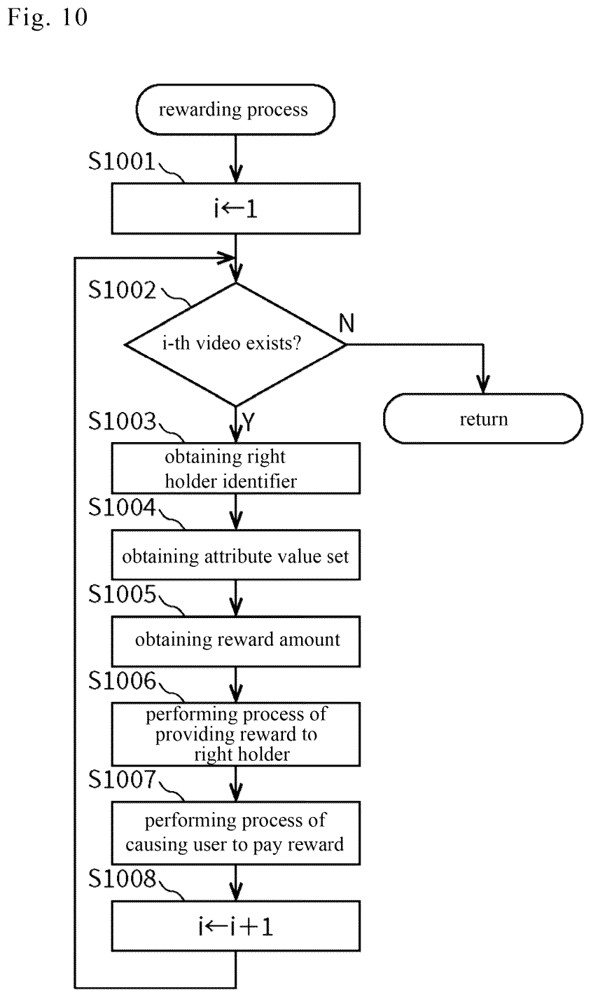

(S420) A rewarding unit 1335 performs the rewarding process. The processing returns to S401. An example of the above described rewarding process will be explained using the flowchart in FIG. 10.

(S421) The video obtainer 131 determines whether or not “current” point of time exists in a plurality of determined points of time. When “current” point of time exists, the processing proceeds to S422. When “current” point of time does not exist, the processing proceeds to S401.

(S422) The video obtainer 131 performs current video obtaining process. An example of the above described current video obtaining process will be explained using the flowchart in FIG. 7.

(S423) The receiver 12 determines whether or not the video or the like is received from the providing terminal 2. When the video or the like is received, the processing proceeds to S423. When the video or the like is not received, the processing returns to S401.

(S424) The processor 13 accumulates the video or the like received in S423 in the storage 11 while being paired with the terminal identifier. The processing returns to S401.

In the flowchart shown in FIG. 4, the information processing device 1 may obtain the video corresponding to the inquiry in accordance with the instruction of transmitting the video from the user terminal 3 and transmit the video to the user terminal 3.

In the flowchart in FIG. 4, the process ends when the power is turned off or the instruction of ending process is interrupted.

Then, an example of the timing determination process in S405 will be explained using the flowchart in FIG. 5.

(S501) The video obtainer 131 determines whether or not the time information exists in the received inquiry. When the time information exists, the processing proceeds to S502. When the time information does not exist, the processing proceeds to S510.

(S502) The video obtainer 131 obtains the time information included in the received inquiry.

(S503) The video obtainer 131 determines whether or not the weather information exists in the received inquiry. When the weather information exists, the processing proceeds to S504. When the weather information does not exist, the processing proceeds to S509.

(S504) The video obtainer 131 obtains the weather information included in the received inquiry.

(S505) The video obtainer 131 obtains the weather information at the location identified by the location information included in the inquiry at the time identified by the time information from a weather server.

(S506) The video obtainer 131 determines whether or not the weather information included in the inquiry and the weather information obtained in S505 match each other. When they match each other, the processing proceeds to S507. When they do not match with each other, the processing proceeds to S508.

(S507) The video obtainer 131 temporarily accumulates the time information paired with the matched weather information in a not-illustrated buffer. The processing proceeds to S514.

(S508) The video obtainer 131 obtains the time information satisfying an approximate condition with the time information included in the inquiry from the weather server and temporarily accumulates time information in a not-illustrated buffer when the weather information matches the weather information included in the inquiry. The processing proceeds to S514.

Note that the approximate condition means that two time information are close to each other. For example, the approximate condition means that the time indicated by the time information included in the inquiry matches and the date indicated by the time information included in the inquiry is the nearest day. For example, the approximate condition means that the time information is nearest to the time information included in the inquiry.

(S509) The video obtainer 131 temporarily accumulates the time information included in the received inquiry in a not-illustrated buffer.

(S510) The video obtainer 131 determines whether or not the weather information exists in the received inquiry. When the weather information exists, the processing proceeds to S511. When the weather information does not exist, the processing proceeds to S516.

(S511) The video obtainer 131 obtains the weather information included in the received inquiry.

(S512) The video obtainer 131 obtains the current date and time from a not-illustrated clock.

(S513) The video obtainer 131 obtains the time information nearest to the current date and time from the weather server, the time information satisfying the location information and the weather information included in the received inquiry. The video obtainer 131 temporarily accumulates the time information in a not-illustrated buffer.

(S514) The video obtainer 131 determines whether or not the time point information indicating the current time is accumulated in a not-illustrated buffer. When the time point information indicating the current position is accumulated, the processing returns to the upstream process. When the time point information indicating the current position is not accumulated, the processing proceeds to S515.

(S515) The video obtainer 131 temporarily accumulates the time information indicating the current time in a not-illustrated buffer. The processing returns to the upstream process.

(S516) The video obtainer 131 obtains a plurality of default time information from the storage 11 and temporarily accumulates the plurality of default time information in a not-illustrated buffer. The processing returns to the upstream process.

The plurality of default time information is the preliminarily determined time information. For example, the plurality of default time information is the time information of the current time and the time information as of one year ago.

In the flowchart in FIG. 5, the video obtainer 131 temporarily accumulates two or more different time point information in a not-illustrated buffer. However, the algorithm for obtaining two or more different time point information is not limited. For example, the video obtainer 131 may temporarily accumulate also the default time information (e.g., one week ago) in a not-illustrated buffer.

Then, an example of the terminal determination process in S410 will be explained using the flowchart in FIG. 6.

(S601) The video obtainer 131 obtains the location information included in the inquiry.

(S602) The video obtainer 131 substitutes 1 for a counter i.

(S603) The video obtainer 131 determines whether or not the i-th terminal information exits in the terminal manager 112. When the i-th terminal information exits, the processing proceeds to S604. When the i-th terminal information does not exit, the processing proceeds to S607.

(S604) The video obtainer 131 obtains the positional information included in the i-th terminal information from the terminal manager 112.

(S605) The video obtainer 131 calculates the distance between the location corresponding to the location information and the location indicated by the positional information obtained in S604.

(S606) The video obtainer 131 increments the counter i by 1. The processing returns to S603.

(S607) The video obtainer 131 obtains the terminal identifier paired with the positional information having the minimum distance calculated in S605 from the terminal manager 112. The processing returns to the upstream process.

Then, an example of the current video obtaining process in S411 will be explained using the flowchart in FIG. 7.

(S701) The video obtainer 131 determines whether or not the video paired with the terminal identifier exists in the mobile storage 113. When the video exists, the processing proceeds to S702. When the video does not exist, the processing proceeds to S703.

(S702) The video obtainer 131 obtains the latest video on the predetermined time from the mobile storage 113 in the videos paired with the terminal identifier. The processing returns to the upstream process. Here, it is normal that the video is continuously transmitted from the providing terminal 2 transmitting the video.

(S703) The video obtainer 131 obtains the terminal communication information paired with the terminal identifier from the terminal manager 112. Then, the video obtainer 131 transmits the transmission instruction to the providing terminal 2 identified by the terminal identifier using the terminal communication information.

(S704) The video obtainer 131 determines whether or not the video is received from the providing terminal 2 from which the transmission instruction is transmitted. When the video is received, the processing proceeds to S705. When the video is not received, the processing returns to S704. Note that the received video is associated with the terminal identifier.

(S705) The video obtainer 131 obtains the video received in S704. The processing returns to the upstream process.

Then, an example of the screen generating process in S414 will be explained using the flowchart in FIG. 8.

(S801) The screen generator 133 obtains the location name corresponding to the location information included in the inquiry. When the location information is the location name, the screen generator 133 obtains the location information. When the location information is the positional information (longitude, latitude), the screen generator 133 obtains the location name paired with the location information using the map information of the storage 11.

(S802) The screen generator 133 substitutes 1 for a counter i.

(S803) The screen generator 133 determines whether or not the i-th video exists in the videos obtained by the video obtainer 131. When the i-th video exists, the processing proceeds to S804. The i-th video does not exist, the processing returns to the upstream process.

(S804) The screen generator 133 arranges the i-th video on a predetermined position of the screen. Note that the information (may be referred to as template information) of the screen on which the video or the like is arranged is stored in the storage 11. The predetermined position of the i-th video is the position not overlapped with the other information of the other video or the like.

(S805) The screen generator 133 obtains one or more attribute values (e.g., time information, weather information, keyword) paired with the i-th video. The screen generator 133 arranges one or more attribute values at the position associated with the i-th video.

(S806) The screen generator 133 increments the counter i by 1. The processing returns to S803.

In the flowchart in FIG. 8, the screen to be transmitted is generated from the arrangement of the videos in S804 and the arrangement of one or more attribute values in S805.

Then, an example of the fourth preservation process in S419 will be explained using the flowchart in FIG. 9.

(S901) The fourth preserver 1344 obtains the access information for identifying the destination in which each of one or a plurality of videos is accumulated in S418.

(S902) The fourth preserver 1344 obtains the attribute value set corresponding to each of one or more accumulated videos.

(S903) The fourth preserver 1344 generates the preservation information including the access information obtained in S901, the attribute value set obtained in S902 and the right holder identifier of the video for each of one or more videos. When a new right holder identifier is obtained, the fourth preserver 1344 generates, for example, the preservation information including the new right holder identifier and the original right holder identifier.

(S904) The fourth preserver 1344 accumulates the preservation information generated in S903. The processing returns to the upstream process.

When the preservation information of the video corresponding to the preservation information to be accumulated is accumulated in S904, the preservation information is overwritten on the preservation information generated in S903. By the above described operation, the transition of the right holder of the video can be managed, for example. In addition, the fourth preserver 1344 accumulates the preservation information in a blockchain, for example.

Then, an example of the rewarding process in S420 will be explained using the flowchart in FIG. 10.

(S1001) The rewarding unit 1345 substitutes 1 for a counter i.

(S1002) The rewarding unit 1345 determines whether or not the i-th video, which is the source for generating the screen, exists. When the i-th video exists, the processing proceeds to S1003. When the i-th video does not exist, the processing returns to the upstream process.

(S1003) The rewarding unit 1345 obtains the right holder identifier paired with the target video.

(S1004) The rewarding unit 1345 obtains the attribute value set of the target video.

(S1005) The rewarding unit 1345 obtains the reward amount using the attribute value set obtained in S1004.

(S1006) The rewarding unit 1345 performs the process of providing the reward to the right holder identified by the right holder identifier obtained in S1003 by the reward amount obtained in S1005.

(S1007) The rewarding unit 1345 performs the process of causing the user corresponding to the user terminal 3 receiving the screen to pay the reward.

(S1008) The rewarding unit 1345 increments the counter i by 1. The processing returns to S1002.

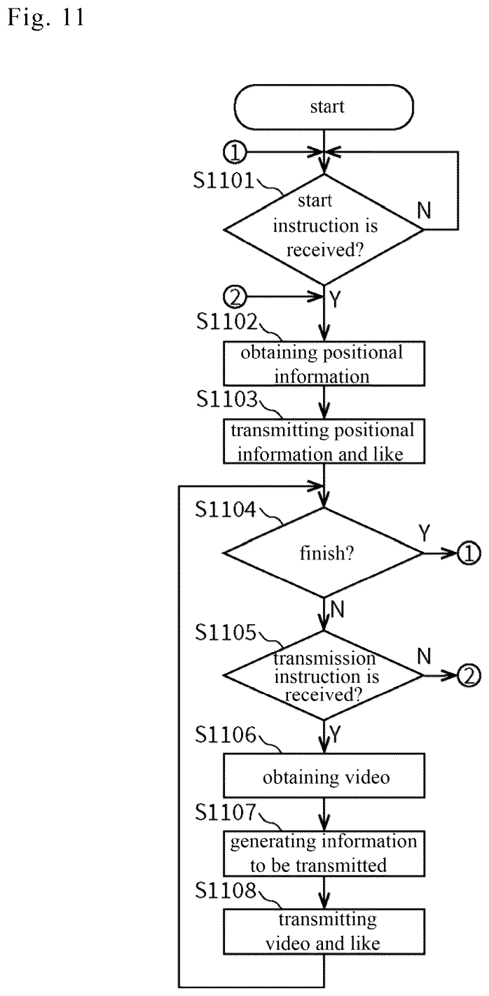

Then, the first operation example of the providing terminal 2 will be explained using the flowchart in FIG. 11. The first operation example is the case where the video is transmitted to the information processing device 1 when the transmission instruction is received by the providing terminal 2 as a trigger.

(S1101) The providing terminal 2 determines whether or not a start instruction is received. When the start instruction is received, the processing proceeds to S1102. When the start instruction is not received, the processing proceeds to S1101.

(S1102) The position obtainer 231 obtains the current positional information of the providing terminal 2.

(S1103) The mobile processor 23 obtains the terminal identifier from a mobile storage 21. Then, the mobile processor 23 generates the information including the terminal identifier and the positional information obtained in S1102. A mobile transmitter 24 transmits the above described information to the information processing device 1.

(S1104) The mobile processor 23 determines whether or not to finish the process. When the process will be finished, the processing returns to S1101. When the process will not be finished, the processing returns to Step S1105. Note that the case when the process will be finished is, for example, when the end instruction is received from the user.

(S1105) A mobile receiver 22 determines whether or not the transmission instruction is received from the information processing device 1. When the transmission instruction is received, the processing proceeds to S1106. When the transmission instruction is not received, the processing returns to S1102.

(S1106) The image capturer 232 obtains the video.

(S1107) The attribute value obtainer 233 obtains one or more attribute values. The generator 234 obtains the terminal identifier from the mobile storage 21. The generator 234 generates the information to be transmitted by associating one or more attribute values and the terminal identifier with the video. Note that the time information obtained by the attribute value obtainer 233 and the positional information or the like obtained by the position obtainer 231 are, for example, associated with each of the frames constituting the video. In addition, the weather information or the like obtained by the attribute value obtainer 233 is, for example, associated with one or a plurality of frames constituting the video.

(S1108) The mobile transmitter 24 transmits the video or the like generated in S1107 to the information processing device 1. The processing returns to S1104. Note that the length of the video and the data amount of the video transmitted by the mobile transmitter 24 at once are not limited.

In the flowchart in FIG. 11, the image capturer 232 starts capturing the video when the transmission instruction is received. However, the image capturer 232 may start capturing the video when the transmission instruction is received.

In the flowchart in FIG. 11, the process ends when the power is turned off or the instruction of ending process is interrupted.

Then, the second operation example of the providing terminal 2 will be explained. The second operation example is the case where the providing terminal 2 continuously transmits the captured videos to the information processing device 1 without receiving the instruction from the information processing device 1.

The providing terminal 2 receives a start instruction. Then, the position obtainer 231 obtains the positional information. In addition, the image capturer 232 captures the images to obtain the video. In addition, the attribute value obtainer 233 obtains one or more attribute values. Then, the generator 234 generates the video or the like to be transmitted. Then, the providing transmitter 24 transmits the video or the like to the information processing device 1 while being associated with the terminal identifier. The providing terminal 2 repeats the above described process until the end instruction is received. Note that the video or the like transmitted by the providing terminal 2 is a so-called additional video.

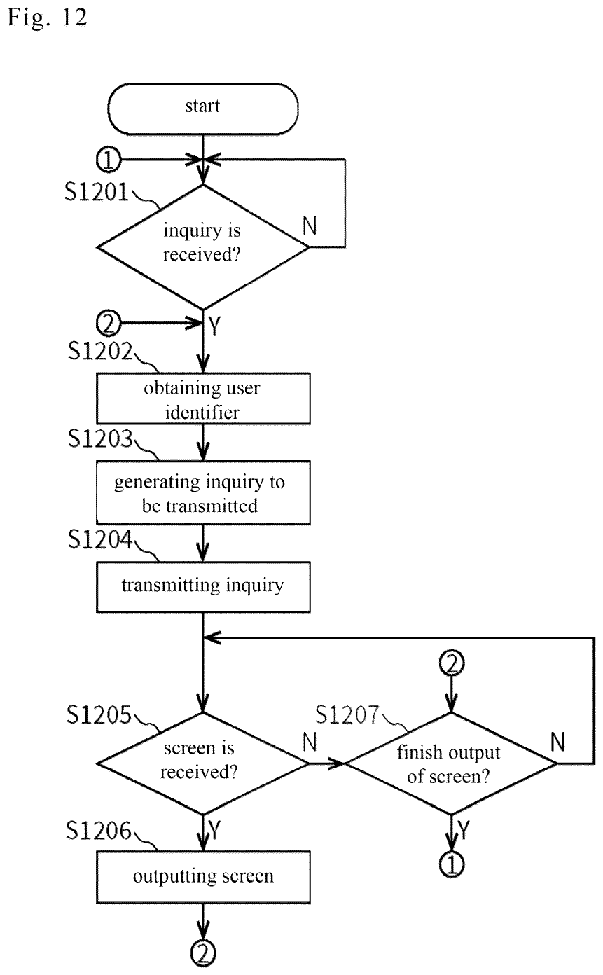

Then, the operation example of the user terminal 3 will be explained using the flowchart in FIG. 12.

(S1201) The user acceptor 32 determines whether or not the inquiry is received. When the inquiry is received, the processing proceeds to S1202. When the inquiry is not received, the processing returns to S1201.

(S1202) The user processor 33 obtains the user identifier of the user storage 31.

(S1203) An inquiry obtainer 332 generates the inquiry to be transmitted using the inquiry received by S1201. Note that the inquiry to be transmitted is normally associated with the user identifier. The inquiry to be transmitted includes, for example, the positional information obtained by the user processor 33 or the location identifier obtained by the user processor 33.

(S1204) The user transmitter 34 transmits the inquiry generated in S1203 to the information processing device 1.

(S1205) The user receiver 35 determines whether or not the screen is received from the information processing device 1. When the screen is received, the processing proceeds to S1206. When the screen is not received, the processing proceeds to S1207.

(S1206) The user processor 33 generates the screen to be outputted based on the received screen. The user output unit 36 outputs the screen.

(S1207) The user processor 33 determines whether or not to finish the output of the screen. When the output of the screen will be finished, the processing returns to S1201. When the output of the screen will not be finished, the processing returns to S1205. Note that the case when the output of the screen will be finished is, for example, when the end instruction is received from the user.

In the flowchart in FIG. 12, the user terminal 3 may receive the instruction of the user with respect to the window of a plurality of videos in the screen, transmits the instruction to the information processing device 1, receives the video corresponding to the instruction from the information processing device 1, and reproduce the video in the window corresponding to the instruction.

In the flowchart in FIG. 12, the process ends when the power is turned off or the instruction of ending process is interrupted.

### Specific Examples

Hereafter, specific examples of the operation of the information system A in the present embodiment will be explained.

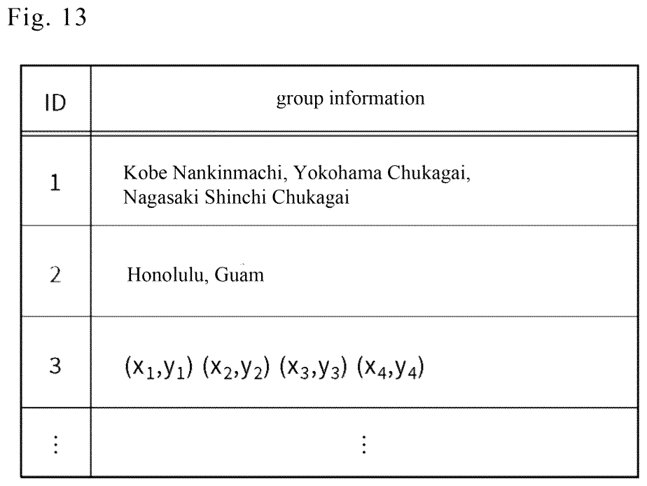

It is assumed that a group management table shown in FIG. 13 is stored in the group manager 111 of the information processing device 1. The group management table is the table for managing the group information. The group management table is the table for managing a plurality of related locations. The group management table manages the record including “ID” and “group information.” The “ID” is the information for identifying the record. The “group information” is the location information. The location information is the location name or a set of a longitude and a latitude.

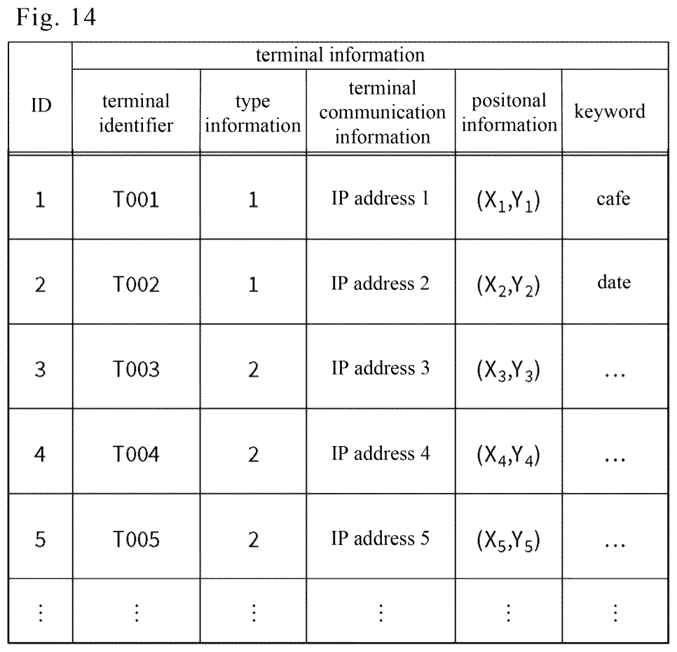

It is assumed that a terminal management table shown in FIG. 14 is stored in the terminal manager 112. The terminal management table manages the record including “ID” and “terminal information.” The “terminal information” here includes “terminal identifier,” “type information,” “terminal communication information,” “positional information” and “keyword.” The “type information” is the information for identifying the type of the providing terminal 2. The type information “1” is the fixed terminal while “2” is the mobile terminal. The “positional information” is the positional information of the providing terminal 2. When the providing terminal 2 is the mobile terminal, the “positional information” is the latest positional information of the mobile terminal. The “keyword” here is the term that symbolizes the place where the fixed terminal is located.

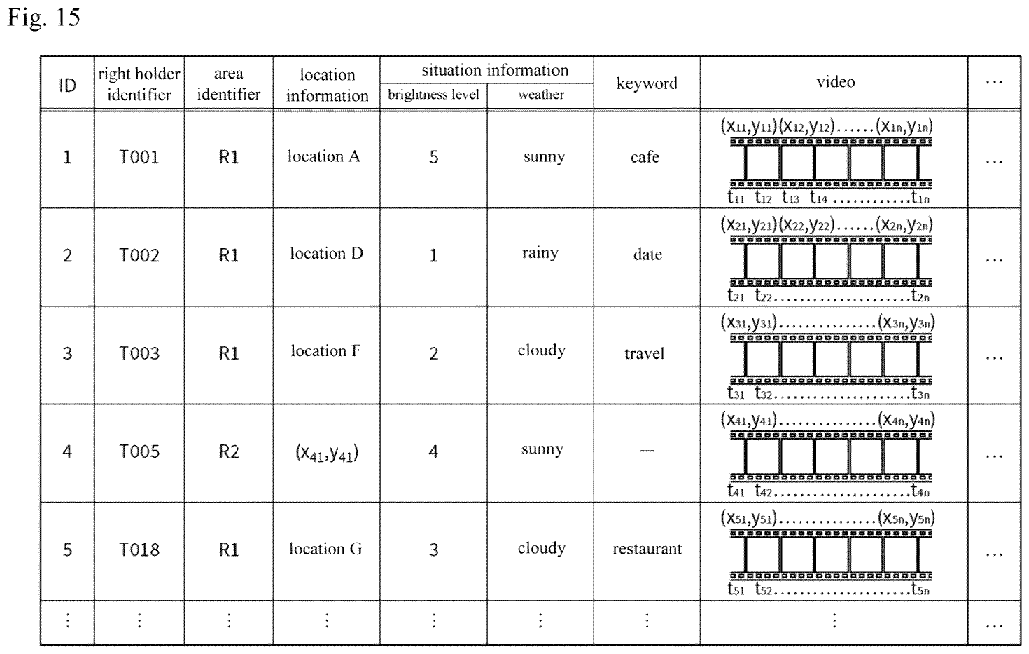

A video management table shown in FIG. 15 is stored in the mobile storage 113. The video management table is the table for managing the right holder identifier and the video or the like. The video management table includes “ID,” “right holder identifier,” “area identifier,” “location information,” “situation information,” “keyword” and “video.” The “situation information” is the information identifying “brightness level” and “weather information.” The “ID” is the information for identifying the record. The “right holder identifier” is the terminal identifier of the providing terminal 2 transmitting the video. However, the “right holder identifier” may be the identifier of the user of the providing terminal 2 transmitting the video. Furthermore, the “right holder identifier” may be the identifier of the user using the video or purchasing the video. The “area identifier” is the information for identifying the area including the location where the providing terminal 2 is located. The “location information” is the information for identifying the location where the video is captured. The “brightness level” here may be any one of the values of 1 to 5, for example. The brightness level “1” means “extremely dark.” “2” means “dark,” “3” means “slightly dark,” “4” means “bright” and “5” means “extremely bright.” The “weather information” here is the weather information at the location where the video is captured and at the time when the video is captured. The “keyword” is the term corresponding to the object to be captured or the location where the video is captured. The “video” here is the additional video. Here, the positional information (x, y) and date and time (t) are associated with the still image constituting the additional video.

It is assumed that a part or an entire providing terminals 2 in a large number of providing terminals 2 continuously (always) transmits the captured video and one or more attribute values (here, location information, weather information, keyword) to the information processing device 1 while being paired with the terminal identifier. In addition, it is assumed that the information processing device 1 receives the video or the like from a plurality of providing terminals 2 and accumulates the video or the like in the video management table.

In the above described situation, the following six specific examples will be explained. The specific example 1 is the case where the user inputs the inquiry including only the location information and obtains the current video identified by the location information and the video at the time satisfying a predetermined condition. Note that the predetermined condition here is the weather information in the weather forecast during the first period (e.g., within one week) from the current and at the same or similar time in the past during the second period (e.g., within two weeks before and after) from the current date (e.g., 11/13). Note that the past date may be the date of the year prior to the last year. The specific example 2 is the case where the user inputs the inquiry including only the location information and the time information (here, future date) and obtains the video identified by the location information with the weather information indicated by the weather information of the future date identified by the time information within the second period (e.g., within two weeks before and after) from the current date (e.g., 11/13) at the past date same as or near to the current date. The specific example 3 is the case where the user inputs the inquiry including the location information and the weather information and obtains the video at the location identified by the location information at the current time and the video at the past time corresponding to the location information and the weather information included in the inquiry. The specific example 4 is the case where the user inputs the inquiry including the location information and a plurality of points in time and obtains the video at the location identified by the location information at each of the plurality of points in time. The specific example 5 is the case where the user inputs the inquiry including the location information, the time information and the keyword and obtains the video at the location identified by the location information (location corresponding to the keyword) at the time indicated by the time information and the current video at the location identified by the location information (location corresponding to the keyword). It is assumed that the location information here is the area identifier. The specific example 6 is the case of providing the screen including the video at two or more points of time corresponding to the location information related to the location information when the video corresponding to the location information inputted by the user does not exist.

### Specific Example 1

It is assumed that the user launches an application “situation search” for obtaining the video at a predetermined location at a plurality of points in time. It is assumed that the above described application is installed in the user terminal 3.

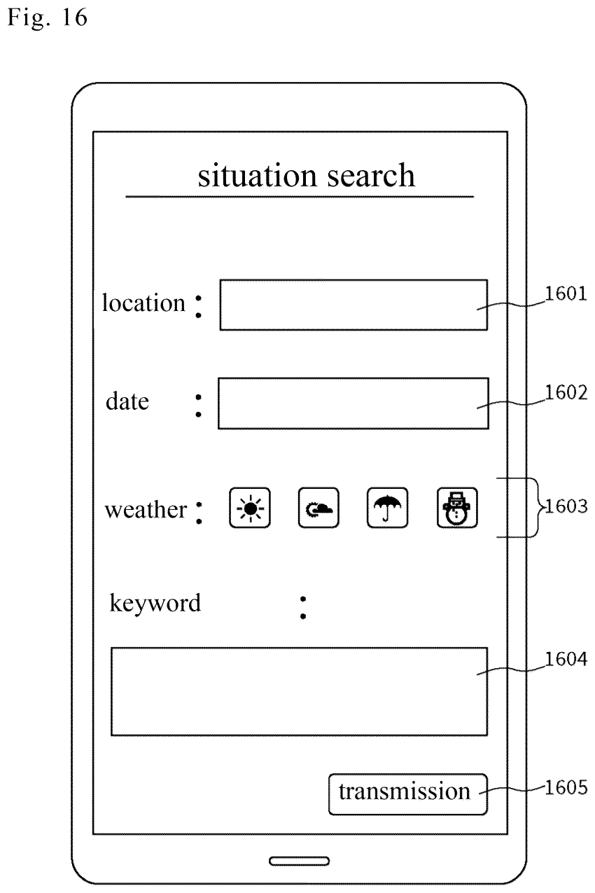

Thus, the screen of the application “situation search” is outputted to the user terminal 3. An example of the above described screen is FIG. 16. Note that the location field 1601 is the field for inputting the location information in FIG. 16. The date field 1602 is the field for inputting the time information. The weather field 1603 here includes four selectable weather icons. The user can select one or a plurality of weather icons. The keyword field 1604 is the field for inputting one or more keywords.

Then, it is assumed that the user inputs “location A” in the location field 1601 of the screen (FIG. 16) and instructs “transmission” button 1605. It is assumed that the user is scheduled to visit the location A in the near future and wants to know the state of the location A in a predetermined period.

Then, the user acceptor 32 of the user terminal 3 accepts the inquiry “<location> location A.” Then, the user processor 33 obtains the user identifier “U001” of the user storage 31. Then, the inquiry obtainer 332 generates the inquiry “<user identifier> U001<location> location A” to be transmitted using the received inquiry. Then, the user transmitter 34 transmits the above described inquiry to the information processing device 1.

Then, the inquiry receiver 122 of the information processing device 1 receives the above described inquiry from the user terminal 3. Then, the video obtainer 131 obtains the location information “location A” included in the inquiry.

Then, the video obtainer 131 determines the video at a plurality of points in time in the following manner. Namely, it is assumed that the video obtainer 131 obtains the current date and time “2022 Nov. 13 12:00” from a not-illustrated clock. Then, it is assumed that the video obtainer 131 obtains the weather forecast (e.g., “<2022 Nov. 13> sunny <2022 Nov. 14> cloudy <2022/11/15> rainy . . . <2022/11/19> sunny”) at the location identified by the location information “location A” during a predetermined period (one week) from a not-illustrated weather server. Namely, it is assumed that the weather forecast at the location A during the first period is one of “sunny,” “cloudy” and “rainy.”

Then, the video obtainer 131 receives the current video paired with the location information “location A” from the providing terminal 2 identified by the terminal identifier “T001” paired with the location A. In addition, the past video paired with the location information “location A” and the weather information “cloudy” and paired with the time information of the date within two weeks before and after from the date “11/13” is obtained from the mobile storage 113. Here, it is assumed that the video obtainer 131 obtains the past video corresponding to “2022 Nov. 5 12:00” from the mobile storage 113. It is assumed that the weather is cloudy at the location A at “2022 Nov. 5 12:00.” Furthermore, the past video paired with the location information “location A” and the weather information “rainy” and paired with the time information of the date within two weeks before and after the date “11/13” is obtained from the mobile storage 113. Here, it is assumed that the video obtainer 131 obtains the past video corresponding to “2022 Nov. 10 12:00” from the mobile storage 113.

In addition, the video obtainer 131 associates the attribute value (here, weather information, date) at each of the obtained three points of time with the video.

Then, the screen generator 133 generates the screen based on the obtained three videos. Here, the screen generator 133 arranges the weather forecast from “2022 Nov. 13” to “2022 Nov. 19” obtained from the weather server on the screen. In addition, the screen generator 133 generates three video windows and arranges the video on each of the video windows. In addition, the screen generator 133 arranges the attribute value (weather information, date) at the position associated with each of the video windows. The screen is generated by the above described process. Then, the screen transmitter 141 transmits the generated screen to the user terminal 3 from which the inquiry is transmitted.

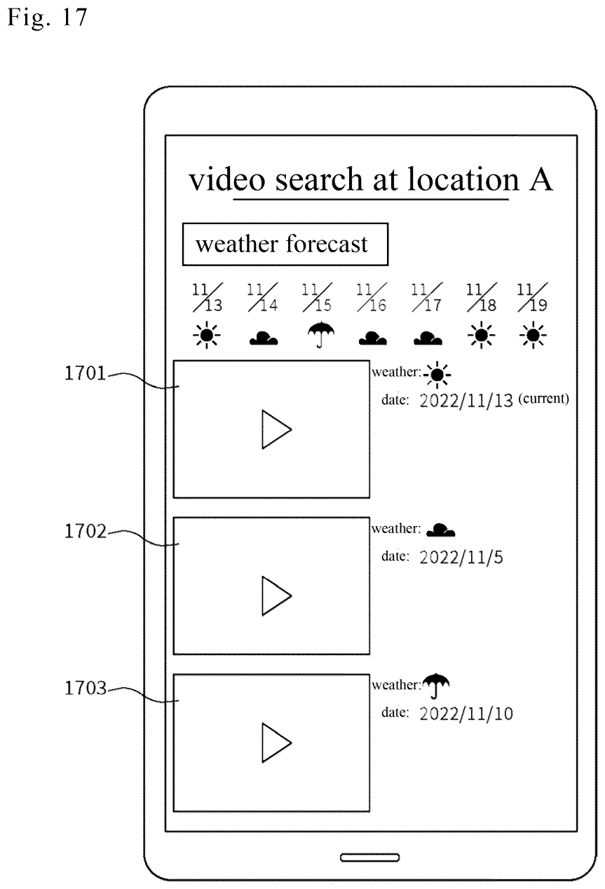

Then, the user terminal 3 receives and outputs the above described screen. An example of the above described screen is FIG. 17. In FIG. 17, 1701 is the window of the current image at the location A on a sunny day. 1702 is the window of the image of “2022 Nov. 5” on a cloudy day. 1703 is the window of the image of “2022 Nov. 10” on a rainy day. In FIG. 17, each video of 1701, 1702 and 1703 is reproduced by the instruction of the user. In FIG. 17, when the user terminal 3 outputs the screen, one or more videos may be reproduced.

As described above, in the specific example 1, the user can obtain the image of the location identified by the location information with the weather that matches the weather forecast during the predetermined period only by inputting the location information. Consequently, the user can realize what the location identified by the predetermined location information looks like under possible weather condition. Thus, the date visiting the location can be determined or the outfits worn by people in the video can be used as inspiration for what to wear.

### Specific Example 2

When the screen shown in FIG. 16 is displayed on the user terminal 3, it is assumed that the user inputs “location A” in the location field 1601 of the screen and the future date “2022 Nov. 15” in the date field and instructs “transmission” button 1605. Note that the user is planning to visit the location A on 2022 Nov. 15.

Then, the user acceptor 32 of the user terminal 3 accepts the inquiry “<location> location A <date> 2022 Nov. 15.” Then, the user processor 33 obtains the user identifier “U001” of the user storage 31. Then, the inquiry obtainer 332 generates the inquiry “<user identifier> U001<location> location A <date>2022 Nov. 15” to be transmitted using the received inquiry. Then, the user transmitter 34 transmits the above described inquiry to the information processing device 1.

Then, the inquiry receiver 122 of the information processing device 1 receives the above described inquiry from the user terminal 3. Then, the video obtainer 131 obtains the location information “location A” included in the inquiry.

In addition, the video obtainer 131 obtains a plurality points of time in the following manner. Namely, the video obtainer 131 obtains the current date and time “2022 Nov. 13 12:00” from a not-illustrated clock. Then, the video obtainer 131 obtains the date and time “2022 Nov. 13 12:00” using the date included in the inquiry and the current time “12:00.” Then, the video obtainer 131 obtains the information of the weather forecast “rainy” at the location information “location A” at “2022 Nov. 15 12:00” from a not-illustrated weather server. Then, it is assumed that the video obtainer 131 obtains the date and time (e.g., “2021 Nov. 14 12:00”) paired with the location information “location A” and the date satisfying the second period (here, within two weeks before and after) from the date “11/15,” paired with the time “12:00” and paired with the weather information “rainy” from the weather server. Namely, it is assumed that the video obtainer 131 obtains two points of time “current” and “2021 Nov. 14 12:00.”

Then, the video obtainer 131 receives the current video at the location A from the providing terminal 2. In addition, the video obtainer 131 obtains the video paired with the location A and “2021 Nov. 14 12:00” from the mobile storage 113.

In addition, the video obtainer 131 associates the attribute value (here, weather information, date) at obtained two points of time with the video.

Then, the screen generator 133 generates the screen based on the obtained two videos. Here, the screen generator 133 arranges the information “rainy” of the weather forecast at the inputted date “2022 Nov. 15 12:00” at a predetermined location. In addition, the screen generator 133 generates two video windows and arranges the video on each of the video windows. In addition, the screen generator 133 arranges the attribute value (weather information, date) at the location associated with each of the video windows. The screen is generated by the above described process. Then, the screen transmitter 141 transmits the generated screen to the user terminal 3 from which the inquiry is transmitted.

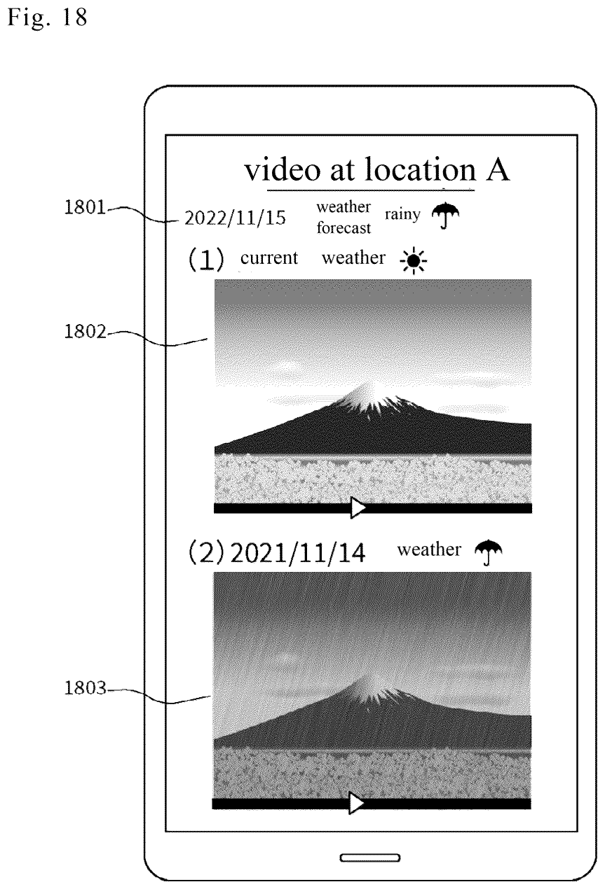

Then, the user terminal 3 receives and outputs the above described screen. An example of the above described output is FIG. 18. 1801 of FIG. 18 is the information of the weather forecast of the date inputted by the user. In addition, FIG. 18 is the screen comparing and outputting the video (1802) at the current time and the video (1803) at the past rainy day which is the date same as or near to the current date.

As described above, in the specific example 2, it is possible to obtain the current video at the location information inputted by the user and the video corresponding to the predicted weather of the date inputted by the user.

Note that the video included in the specific example 2 may be only the video of 1803. Namely, in the above described case, the screen generator 133 generates the screen using one video. Also in the above described case, the user can obtain the video corresponding to the predicted weather on the day of the visit at the location of the visit during the same season as the visit. Consequently, the outfits worn by people in the video can be used as inspiration for what to wear, for example.

### Specific Example 3

When the screen shown in FIG. 16 is displayed on the user terminal 3, it is assumed that the user inputs “location A” in the location field of the screen, selects “rainy” from the weather icon in the weather field 1603 and instructs “transmission” button 1605. It is assumed that the user wants to know the situation of the location A on a rainy day.

Then, the user acceptor 32 of the user terminal 3 accepts the inquiry “<location> location A <weather information> rainy.” Then, the user processor 33 obtains the user identifier “U001” of the user storage 31. Then, the inquiry obtainer 332 generates the inquiry “<user identifier> U001<location> location A <weather information> rainy” to be transmitted using the received inquiry. Then, the user transmitter 34 transmits the above described inquiry to the information processing device 1.

Then, the inquiry receiver 122 of the information processing device 1 receives the above described inquiry from the user terminal 3. Then, the video obtainer 131 obtains the location information “location A” included in the inquiry.

In addition, the video obtainer 131 obtains a plurality of points in time in the following manner. Namely, the video obtainer 131 obtains the current date and time “2022 Nov. 13 12:00” from a not-illustrated clock. Then, the video obtainer 131 obtains the date and time “11/13 12:00” using the date included in the inquiry and the current time “12:00.” Then, it is assumed that the video obtainer 131 obtains the date “2021 Nov. 14 12:00” which is the date having the weather information “rainy” within the second period (here, one week before and after) at the same time “12:00” with respect to the location information “location A” and the date “11/13 12:00” regardless of the year from the weather server. Namely, it is assumed that the video obtainer 131 obtains two points of time “current” and “2021 Nov. 14 12:00.”

Then, the video obtainer 131 receives the current video of the location A from the providing terminal 2. In addition, the video obtainer 131 obtains the video paired with the location A and “2021 Nov. 14 12:00” from the mobile storage 113.

In addition, the video obtainer 131 associates the attribute value (here, weather information, date) at obtained two points of time with the video.

Then, the screen generator 133 generates the screen based on the obtained two videos. Here, the screen generator 133 generates two video windows and arranges the video on each of the video windows. In addition, the screen generator 133 arranges the attribute value (weather information, date) at the location associated with each of the video windows. The screen is generated by the above described process. Then, the screen transmitter 141 transmits the generated screen to the user terminal 3 from which the inquiry is transmitted.

Then, the user terminal 3 receives and outputs the above described screen. An example of the above described output is the screen of FIG. 18 without 1801. FIG. 18 is the screen comparing and outputting the video (1802) at the current time and the video (1803) at the past rainy day which is the date same as or near to the current date.

As described above, in the specific example 3, the user can view the video corresponding to the inputted location information and weather information and the current video of the location identified by the location information while comparing with each other.

### Specific Example 4

When the screen shown in FIG. 16 is displayed on the user terminal 3, it is assumed that the user inputs “location A” in the location field 1601 of the screen, inputs “2021 Nov. 14” in the date field and instructs “transmission” button 1605. Note that the user who visited at the location A on “2021 Nov. 14” wants to know the change in the situation of location A from the time the user visited the location A to the present.

Then, the user acceptor 32 of the user terminal 3 accepts the inquiry “<location> location A <date>2021 Nov. 14.” Then, the user processor 33 obtains the current time “12:00” from a not-illustrated clock. Then, the user processor 33 obtains the user identifier “U001” of the user storage 31. Then, the inquiry obtainer 332 generates the inquiry “<user identifier> U001<location> location A <date>2021 Nov. 14 12:00” to be transmitted using the received inquiry. Then, the user transmitter 34 transmits the above described inquiry to the information processing device 1.

Then, the inquiry receiver 122 of the information processing device 1 receives the above described inquiry from the user terminal 3. Then, the video obtainer 131 obtains the location information “location A” included in the inquiry.

In addition, the video obtainer 131 obtains a plurality of points in time in the following manner. Namely, the video obtainer 131 obtains the date and time “2021 Nov. 14 12:00” included in the received inquiry. In addition, it is assumed that the video obtainer 131 obtains the time point information “current.”

Then, it is assumed that the video obtainer 131 obtains the terminal communication information “IP address 1” of the providing terminal 2 paired with the positional information (X1, Y1) corresponding to the current location A from the terminal management table (FIG. 14). Then, the video obtainer 131 transmits the transmission instruction to the providing terminal 2 using the terminal communication information “IP address 1.” The video obtainer 131 receives the video currently captured by the providing terminal 2 from the providing terminal 2. In addition, the video obtainer 131 obtains the video paired with the location A and “2021 Nov. 14 12:00” from the mobile storage 113.

In addition, the video obtainer 131 associates the attribute value (here, weather information, date) at the obtained two points of time with the video.

Then, the screen generator 133 generates the screen based on the obtained two videos. Here, the screen generator 133 generates two video windows and arranges the video on each of the video windows. In addition, the screen generator 133 arranges the attribute value (weather information, date) at the location associated with each of the video windows. The screen is generated by the above described process. Then, the screen transmitter 141 transmits the generated screen to the user terminal 3 from which the inquiry is transmitted.

Then, the user terminal 3 receives and outputs the above described screen. An example of the above described output is the screen of FIG. 18 without 1801.

As described above, in the specific example 4, the user can view the video corresponding to the inputted location information and time information and the current video of the location identified by the location information while comparing with each other.

### Specific Example 5

When the screen shown in FIG. 16 is displayed on the user terminal 3, it is assumed that the user inputs the area identifier “R1” in the location field 1601 of the screen, inputs “2022 Nov. 25” in date field 1602, inputs “date” in “keyword” and instructs “transmission” button 1605. Note that the user is planning to visit “R1” on the date “2022 Nov. 25” for a date.

Then, the user acceptor 32 of the user terminal 3 accepts the inquiry “<location> R1 <date>2022 Nov. 25<keyword> date.” Then, the user processor 33 obtains the user identifier “U001” of the user storage 31. Then, the inquiry obtainer 332 generates the inquiry “<user identifier> U001<location> R1<date>2022 Nov. 25<keyword> date” to be transmitted using the received inquiry. Then, the user transmitter 34 transmits the above described inquiry to the information processing device 1.

Then, the inquiry receiver 122 of the information processing device 1 receives the above described inquiry from the user terminal 3. Then, the video obtainer 131 obtains the area identifier “R1” and the keyword “date” included in the inquiry. Then, the video obtainer 131 obtains the location information “location D” paired with the area identifier “R1” and the keyword “date” from the video management table (FIG. 15). When the terminal management table (FIG. 14) includes the location information, it is preferred that the video obtainer 131 obtains the location information “location D” paired with the area identifier “R1” and the keyword “date” from the terminal management table (FIG. 14). The video obtainer 131 may obtain the location identifier (here, “location D”) based on the map information using the positional information of the terminal management table and the keyword.

In addition, the video obtainer 131 obtains the video at a plurality of points in time in the following manner. Namely, the video obtainer 131 obtains, from the weather server, the predicted weather information “sunny” on the date “2022 Nov. 25” included in the received inquiry at the location information “location D.” Then, the video obtainer 131 obtains the video at the time corresponding to the location information “location D” and the weather information “sunny” at one or a plurality of points in time within the second period “here, one week” with respect to the date “11/25” included in the inquiry from the video management table (FIG. 15). In addition, the video obtainer 131 obtains the current video from the providing terminal 2 corresponding to the location information “location D.”

In addition, the video obtainer 131 associates the attribute value (here, weather information, date) at each of the obtained plurality of points in time with the video.

Then, the screen generator 133 generates the screen based on the obtained plurality of video. Here, the screen generator 133 generates a plurality of video windows and arranges the video on each of the video windows. In addition, the screen generator 133 arranges the attribute value (weather information, date) at the location associated with each of the video windows. The screen is generated by the above described process. Then, the screen transmitter 141 transmits the generated screen to the user terminal 3 from which the inquiry is transmitted.

Then, the user terminal 3 receives and outputs the above described screen.

As described above, in the specific example 5, the user can view the videos at a plurality of points in time corresponding to the location information, the time information and the keyword inputted by the user.

### Specific Example 6

When the screen shown in FIG. 16 is displayed on the user terminal 3, it is assumed that the user inputs the location information “Honolulu” in the location field 1601 of the screen and instructs “transmission” button 1605.

Then, the user acceptor 32 of the user terminal 3 accepts the inquiry “<location> Honolulu.” Then, the user processor 33 obtains the user identifier “U001” of the user storage 31. Then, the inquiry obtainer 332 generates the inquiry “<user identifier> U001<location> Honolulu” to be transmitted using the received inquiry. Then, the user transmitter 34 transmits the above described inquiry to the information processing device 1.

Then, the inquiry receiver 122 of the information processing device 1 receives the above described inquiry from the user terminal 3. Then, the video obtainer 131 obtains the location information “Honolulu” included in the inquiry. It is assumed that the video obtainer 131 inspects the positional information in the terminal management table (FIG. 14) and the location information in the video management table (FIG. 15) and determines that there is no providing terminal 2 capable of transmitting the video of the location information “Honolulu” and there is no past video of the location information “Honolulu.”

Then, the video obtainer 131 obtains the location information “Guam” paired with the location information “Honolulu” from the group management table (FIG. 13).

Then, the video obtainer 131 obtains the terminal identifier paired with the positional information corresponding to the location information “Guam” from the terminal management table (FIG. 14). Then, the video obtainer 131 obtains the time point information indicating “current” which is the default time and the time point information (2022/11/6) corresponding to “one week before.”

Then, the video obtainer 131 receives the video from the providing terminal 2 identified by the obtained terminal identifier. In addition, the video obtainer 131 obtains the video corresponding to the location information “Guam” and the time point information (2022/11/6) from the video management table (FIG. 15).

In addition, the video obtainer 131 associates the attribute value (here, weather information, date) at the obtained two points of time with the video.

Then, the screen generator 133 generates the screen based on the obtained two videos.

Then, the user terminal 3 receives and outputs the above described screen.

As described above, in the specific example 6, the user can obtain the video at the location related to the location information even when the video of the inputted location information does not exist.

As described above, in the present embodiment, the video of a predetermined location at a plurality of points in time can be provided. In particular, in the present embodiment, the screen including the videos of a predetermined location at present and past points in time can be provided.

In the present embodiment, the information of a predetermined location at future point in time can be also provided. Note that the information at future point in time is, for example, the information of the predicted weather.

In the present embodiment, the video of a predetermined location corresponding to the information of the predicted weather at future point in time can be also provided.

In the present embodiment, the video can be searched using the location, the time and the weather.

In the present embodiment, the video of the other location related to a predetermined location can be provided.

Furthermore, in the present embodiment, the video of the other location related to a predetermined location can be provided when the video of the location identified by the location information included in the inquiry cannot be obtained.

The processes in the present embodiment may be implemented with software. The software may be distributed by, for example, downloading the software. The software may be recorded in a recording medium such as a compact disk read-only memory (CD-ROM) for distribution. The same applies to another embodiment herein. Note that the software for achieving the information processing device 1 of the present embodiment is the following program. Namely, this program causes the computer to function as: an inquiry receiver configured to receive an inquiry including a location information; a video obtainer configured to obtain a video at a location identified by the location information included in the inquiry at two or more points in time; a screen generator configured to generate a screen using the video at the two or more points in time; and a screen transmitter configured to transmit the screen to the user terminal.

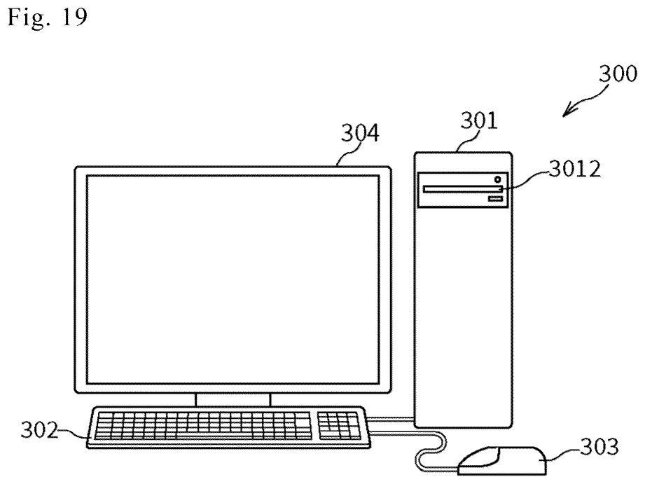

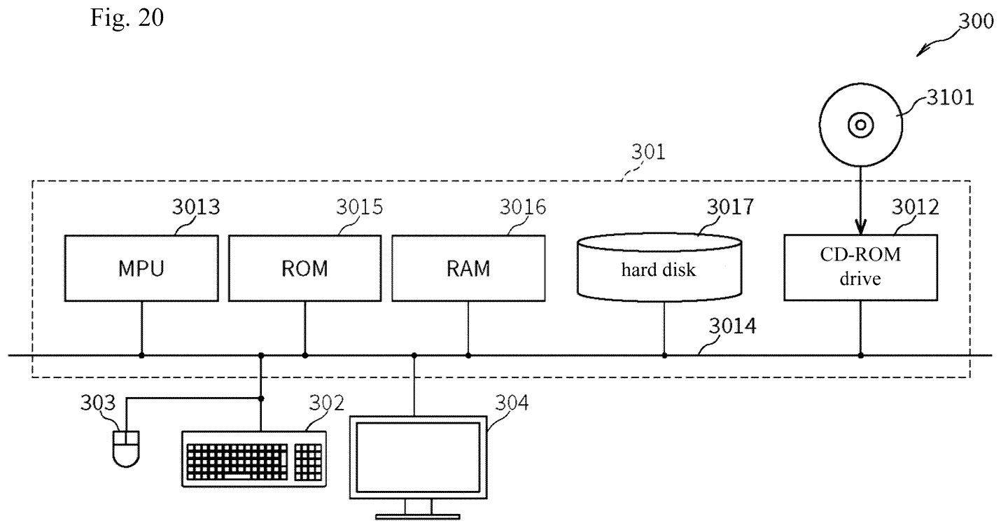

FIG. 19 shows the external appearance of a computer that executes the program described in this specification and achieves the information processing device 1 or the like according to the various kinds of embodiments described above. The above described embodiments can be implemented with computer hardware and a computer program executed on the computer hardware. FIG. 19 is a schematic diagram of a computer system 300 and FIG. 20 is a block diagram of the system 300.

In FIG. 19, the computer system 300 includes a computer 301 including a CD-ROM drive, a keyboard 302, a mouse 303 and a monitor 304.

In FIG. 20, the computer 301 includes a CD-ROM drive 3012, a microprocessor unit (MPU) 3013, a bus 3014 connected to the CD-ROM drive 3012 or the like, a read-only memory (ROM) 3015 storing programs such as a boot-up program, a random access memory (RAM) 3016 connected to the MPU 3013, temporary storing a command from an application program, and providing a temporarily storing space, and a hard disk 3017 storing an application program, a system program and data. Although not shown in the figure, the computer 301 may further include a network card that allows connection to a local area network (LAN).

A program that causes the computer system 300 to function as, for example, the information processing device 1 according to the above described embodiment may be stored in a CD-ROM 3101, inserted into the CD-ROM drive 3012 and transferred to the hard disk 3017. Alternatively, the program may be transmitted to the computer 301 through a not-illustrated network and stored in the hard disk 3017. The program is loaded on the RAM 3016 when the program is executed. The program may be directly loaded from the CD-ROM 3101 or the network.

It is not necessary for the programs to include, for example, a third party program or an operating system (OS) that causes the computer 301 to function as, for example, the information processing device 1 according to the above described embodiment. The programs may be any program that includes a command to call an appropriate function (module) in a controlled manner and obtain an intended result. The manner in which the computer system 300 operates is conventionally known. Thus, the detailed explanation is omitted.

The steps in the above described program, such as transmitting or receiving information, do not include processing performed by hardware, or for example, processing performed by a modem or an interface card in the transmission step (processing performed by hardware alone).

One or more computers may execute the above described program. Namely, either integrated processing or distributed processing may be performed.

In each of the above described embodiments, a plurality of communicators included in a single device may be implemented by a single physical medium.

In each of the embodiments, each process may be performed by a single device through integrated processing or by multiple devices through distributed processing.

The present invention is not limited to the above embodiments, but may be modified variously within the scope of the present invention.

### INDUSTRIAL APPLICABILITY

As described above, the information processing device 1 of the present invention has the effect capable of obtaining the video at a predetermined location at a plurality of points in time and is effective as a server or the like for providing the video at a plurality of points in time.

1. An information processing device comprising:
an inquiry receiver configured to receive an inquiry including a location information;
an image obtainer configured to obtain another location information included in a group information including the location information included in the inquiry from the group information, obtain an image of a location identified by the another location information and obtain the image of the location identified by the location information included in the inquiry, the group information being stored in a group manager storing one or a plurality of group information;
a situation obtainer configured to obtain a situation information for identifying a situation of the location identified by the location information included in the inquiry;
a screen generator configured to generate a screen including the situation information obtained by the situation obtainer based on a plurality of images obtained by the image obtainer; and
a screen transmitter configured to transmit the screen generated by the screen generator to a user terminal.

2. The information processing device according to claim 1, wherein
the situation information includes a weather information for identifying a weather.

3. The information processing device according to claim 1, wherein
the situation information includes an information indicating brightness and darkness of the image.

4. The information processing device according to claim 1, wherein
the situation information includes a weather information for identifying a weather in a future.

5. The information processing device according to claim 1, wherein
the inquiry includes the location information, a time information and the situation information,
the image obtainer is configured to obtain the image corresponding to the location information, the time information and the situation information included in the inquiry from an image storage storing images associated with three or more attribute values including the location information, the time information and the situation information.

6. The information processing device according to claim 1, wherein
the image obtainer is configured to obtain the image of the location identified by the another location information when the image of the location identified by the location information included in the inquiry cannot be obtained.

7. The information processing device according to claim 1, wherein
the image obtainer is configured to obtain the image of the location identified by the location information included in the inquiry at a plurality of points in time.

8. The information processing device according to claim 1, wherein
the image at a plurality of points in time includes a current image and a past image of the location identified by the location information, and
the screen generator is configured to generate the screen including a plurality of images in time order.

9. The information processing device according to claim 1, further comprising:
a third preserver configured to accumulate the image at a plurality of points in time or the screen including the image at the plurality of points in time while being associated with a right holder identifier for identifying a user of the user terminal.

10. A user terminal comprising:
a user acceptor configured to accept an inquiry including a location information;
a user transmitter configured to transmit the inquiry to an information processing device;
a user receiver configured to receive a screen including a situation information for identifying a situation of a location identified by the location information based on images of the location identified by the location information at a plurality of points in time; and
a user output unit configured to output the screen.

11. An information processing method for performing all processes performed by the information processing device according to claim 1.
